(19) United States
(12) Patent Application Publication
(10) Pub. No.: US 2017/0212233 A1
(43) Pub. Date: Jul. 27, 2017

(54) SENSING SYSTEM AND METHOD FOR MEASURING A PARAMETER OF AT LEAST A DIELECTRIC SUBSTANCE IN A TANK; LAYER THICKNESS AND DIELECTRIC PROPERTY MEASUREMENTS IN MULTILAYER SYSTEMS

(71) Applicants: Pedram MOUSAVI, Edmonton (CA); Adam MAUNDER, Edmonton (CA)

(72) Inventors: Pedram MOUSAVI, Edmonton (CA); Adam MAUNDER, Edmonton (CA)

(21) Appl. No.: 15/328,444

(22) PCT Filed: Jan. 23, 2017
(86) PCT No.: PCT/CA2015/000438

§ 371 Date: Jan. 23, 2017

Related U.S. Application Data
(60) Provisional application No. 62/026,909, filed on Jul. 21, 2014.
(60) Provisional application No. 62/026,914, filed on Jul. 21, 2014.

(51) Int. Cl. G01S 13/88; G01F 23/284; G01S 13/02; G01B 15/02

(52) U.S. Cl. CPC G01S 13/88; G01B 15/02; G01F 23/284; G01S 13/0209

(57) ABSTRACT

The sensing system for measuring a parameter of a dielectric substance generally has a tank for containing the dieletric substance; a directional sensor having; an antenna comprising at least one array of at least two antenna elements, the antenna elements being ultra-wide band antenna elements, the antenna being mounted to the tank and adapted to emit a signal comprising radiated electromagnetic energy toward the at least one dielectric substance and along a signal path, the antenna being further adapted to detect a signal after propagation thereof along the signal path; an antenna controller being operatively coupled to the antenna, the antenna controller being adapted to drive the emitted signal based on emission data, adapted to detect the detected signal and to generate detection data indicative of the detected signal; and a computing device operatively coupled to the antenna controller, the computing device being configured to determine the parameter. Methods and apparatus for evaluating properties of layered substances in tanks are disclosed. In particular, such properties can include a layer thickness of a first substance, a layer thickness of a second substance and also one or more dielectric properties of the substances in a multilayer system. The methods and apparatus involve the transmission of radiated electromagnetic energy toward the multilayer system and the detection of radiated electromagnetic energy reflected from the multilayer system to evaluate one or more properties of the layered substances.

### CROSS-REFERENCE TO RELATED APPLICATIONS

This application claims priority and the benefit of U.S. Provisional Application Nos. 62/026,909 and 62/026,914, respectively entitled SENSING SYSTEM AND METHOD FOR MEASURING A PARAMETER OF AT LEAST A DIELECTRIC SUBSTANCE IN A TANK and LAYER THICKNESS AND DIELECTRIC PROPERTY MEASUREMENTS IN MULTILAYER SYSTEMS, both filed on Jul. 21, 2014. These applications are hereby incorporated by reference in their entireties.

### FIELD

In a first broad aspect, the improvements generally relate to the field of measuring parameters of at least one dielectric substance in a tank, and more particularly to the field of measuring a level or dielectric permittivity of at least one dielectric substance.

In another broad aspect, the disclosure relates generally to the evaluation of properties of multilayer systems, and more particularly to apparatus and methods for measuring layer thicknesses of substances of multilayer systems in tanks and also dielectric properties of such substances.

### BACKGROUND

In a first broad aspect related to a sensing system and method for measuring a parameter of at least a dielectric substance in a tank, level sensors can be provided in various forms and involving different technologies. For instance, capacitive level sensors can be used to determine a level of a substance. Typically, these capacitive level sensors comprise a capacitive circuitry having a capacitive parameter that, when immersed in the substance, varies as the level of the substance varies. While the capacitive level sensors provide some advantages, they are inherently intrusive in nature. Alternatively, contactless level sensors such as ultrasonic level sensors can also be used to determine a level of a substance. These ultrasonic sensors typically have a transducer adapted to emit high frequency acoustic waves toward a substance and to further detect the reflections of the acoustic waves. Then, based on properties of the reflected waves, a level of the substance can be determined. Typically, these ultrasonic level sensors require the use of stilling wells and wave guides in insure to prevent improperly reflected acoustic waves. There thus needed room for improvement.

In another broad aspect in relation to layer thickness and dielectric property measurements in multilayer systems, liquid level measurement using antenna pulsed radar is known and typically comprises a simple time-of-flight calculation that is then compared to some time-delay reference. However, for evaluating properties of substances in multilayer systems, existing techniques are typically computationally intensive and can result in a large amount of data collected. Accordingly, such existing techniques for evaluating multilayer systems may not be appropriate for applications where limited computational resources are available.

Some existing techniques for evaluating the dielectric properties using pulsed radar require that the transmitting and receiving antennas be disposed on opposite sides of the sample material and this requirement can render such techniques impractical and undesirable for some situations.

Ground penetrating radar is another measurement technique but typically relies on advanced knowledge of the main dielectric material's electrical properties and typically does not provide very precise distance measurements because high levels of precision in the location of buried dielectrics is typically not required.

### SUMMARY

As demonstrated herein, radar sensors can provide an interesting alternative to ultrasonic or capacitive sensors. Radar level sensors typically have an antenna to emit a radar pulse through the substance and to detect a detected radar pulse. Then, by some methods (e.g. time-of-flight calculations), a level of the substance can be determined. However, if applied to sense parameters of liquids in reflective tanks, reflections of the radar pulse on internal surfaces of a metallic tank may cause a problematic source of noise.

There is provided a directional level sensor by which the amount of noise can be contained within satisfactory limits. The level sensor can incorporate an antenna having at least one array of at least two antenna elements, an antenna controller and a computing device operatively coupled from one another. The antenna may be used to direct an emitted radar signal towards a substance whilst it may be used to detect a detected radar signal being indicative of the level of the substance. By using such an array of antenna elements having a high transient gain, an intensity of the emitted radar signal may be increased along a signal path. It is therefore possible to limit undesirable reflections from internal walls of a tank using such an array of antenna element.

In accordance with one aspect, there is provided a sensing system for measuring a parameter of at least one dielectric substance, the sensing system comprising: a tank for containing the at least one dielectric substance; a directional sensor having: an antenna comprising at least one array of at least two antenna elements, the antenna elements being ultra-wide band antenna elements, the antenna being mounted to the tank and adapted to emit a signal comprising radiated electromagnetic energy toward the at least one dielectric substance and along a signal path of the tank, the antenna being further adapted to detect a signal after propagation thereof along the signal path; an antenna controller being operatively coupled to the antenna, the antenna controller being adapted to drive the emitted signal based on emission data, adapted to detect the detected signal and to generate detection data indicative of the detected signal; and a computing device operatively coupled to the antenna controller, the computing device comprising a data processor and a medium containing machine-readable instructions executable by the data processor and configured to cause the data processor to determine the parameter of the dielectric substance in the tank based on the detection data.

In accordance with one aspect, there is provided a method for measuring a parameter of at least one dielectric substance in a tank, the method comprising the steps of: emitting a signal comprising radiated electromagnetic energy from a directional sensor having an array of antenna elements into the at least one dielectric substance and along a signal path in the tank, the antenna elements being ultra-wide band antenna elements, the dielectric substance and the tank reflecting the signal; receiving the reflected signal; and measuring the parameter based on the received signal.

In accordance with another aspect, there is provide a level sensor for measuring a parameter of at least one dielectric substance in a tank, the level sensor comprising: an antenna comprising at least one array of at least two antenna elements, the antenna elements being ultra-wide band antenna elements, the antenna being mounted to the tank and adapted to emit a signal comprising radiated electromagnetic energy toward the at least one dielectric substance and along a signal path of the tank, the antenna being further adapted to detect a signal after propagation thereof along the signal path; an antenna controller being operatively coupled to the antenna, the antenna controller being adapted to drive the emitted signal based on emission data, adapted to detect the detected signal and to generate detection data indicative of the detected signal; and a computing device operatively coupled to the antenna controller, the computing device comprising a data processor and a medium containing machine-readable instructions executable by the data processor and configured to cause the data processor to determine the parameter of the dielectric substance in the tank based on the detection data.

The definition of the term “antenna” is to be interpreted in a broad manner which is meant to encompass an “emitting antenna” and a “receiving antenna”. The emitting antenna can have at least two antenna elements while the receiving antenna can have one antenna element. The emitting antenna and the receiving antenna can be disposed next one to the other or disposed remotely from one another.

The definition of the term “parameter” is to be interpreted in a broad manner which encompasses at least a “thickness parameter” and a “dielectric parameter”. Accordingly, a thickness of the thin layer and measurable dielectric properties of the thin layer along with measurable dielectric properties of the layer of dielectric material underneath the thin layer, if any, can be considered to be “parameters”.

Many further features and combinations thereof concerning the present improvements will appear to those skilled in the art following a reading of the instant disclosure.

In various aspects, the disclosure describes methods and systems and methods for evaluating properties of multilayer systems.

In one aspect, the disclosure describes a method for evaluating properties of a multilayer system comprising a first substance and a second substance in a tank where the first substance has a different permittivity than the second substance and the second substance is disposed between the first substance and a wall (e.g., bottom) of the tank. The method comprises
transmitting a signal comprising radiated electromagnetic energy from an antenna toward the multilayer system;
detecting a first reflected signal representative of radiated electromagnetic energy reflected from the first substance;
using a first time difference between the first reflected signal and a baseline time delay determined from a baseline reflected signal, computing a distance between the antenna and the first substance;
using a power relation between the first reflected signal and the baseline reflected signal, computing a permittivity of the first substance;
detecting a second reflected signal representative of radiated electromagnetic energy reflected from the second substance;
using a second time difference between the first reflected signal and the second reflected signal and also using the computed permittivity of the first substance, computing a layer thickness of the first substance.

In another aspect, the disclosure describes an apparatus for evaluating properties of a multilayer system comprising a first substance and a second substance in a tank. The apparatus comprises:
an antenna configured to transmit a signal comprising radiated electromagnetic energy toward the multilayer system and detect radiated electromagnetic energy reflected from the multilayer system; and
a computing device operatively coupled to the antenna, the computing device comprising a data processor and a medium containing machine-readable instructions executable by the data processor and configured to cause the data processor to:
   use data representative of a first reflected signal representative of radiated electromagnetic energy reflected from the first substance detected using the antenna and data representative of a baseline reflected signal to compute a first time difference between the first reflected signal and a baseline time delay;
   use the first time difference to compute a distance between the antenna and the first substance;
   use the data representative of the first reflected signal and the data representative of the baseline reflected signal to compute a power relation between the first reflected signal and the baseline reflected signal;
   use the power relation to compute a permittivity of the first substance;
   use data representative of a second reflected signal representative of radiated electromagnetic energy reflected from the second substance detected using the antenna and the data representative of the first reflected signal to compute a second time difference between the first reflected signal and the second reflected signal; and
   use the second time difference and the computed permittivity of the first substance to compute a layer thickness of the first substance.

Further details of these and other aspects of the subject matter of this application will be apparent from the detailed description and drawings included below.

### DESCRIPTION OF THE FIGURES

In the figures,

FIG. 1 is a schematic view of an example of a system for measuring a parameter of a substance;

FIG. 2 is a schematic side view of an example of an antenna element;

FIG. 3A is an axonometric view of an another exemplary antenna comprising an array of eight of the antenna element of FIG. 2;

FIG. 3B is a photograph of the antenna of FIG. 3A where the antenna elements are operatively coupled together;

FIG. 3C is a schematic top view of the antenna of FIG. 3A;

FIG. 4A is a schematic side view of an example of a power divider;

FIG. 4B is a photograph of the power divider of FIG. 4A;

FIG. 5A shows a plot of simulated and measured return losses (S11) for an array of eight antenna elements;

FIG. 5B shows a plot of simulated and measured scattering parameters (S21, S31 and S41) for an array of eight antenna elements;

FIG. 6A shows a plot of simulated and measured return losses as a function of frequency for the power divider of FIG. 4B;

FIG. 6B shows a plot of simulated and measured scattering parameter (S21) as a function of frequency for the power divider of FIG. 4B;

FIG. 6C shows a plot of simulated and measured scattering parameter (S23) as a function of frequency for the power divider of FIG. 4B;

FIG. 7A shows a plot of measured and simulated spectrum gain as a function of an angle along the H-plane of a single antenna element for three different frequencies;

FIG. 7B shows a plot of measured and simulated spectrum gain as a function of an angle along the H-plane of an array of eight antenna elements for three different frequencies;

FIG. 7C shows a plot of measured and simulated spectrum gain as a function of an angle along the E-plane of a single antenna element for three different frequencies;

FIG. 7D shows a plot of measured and simulated spectrum gain as a function of an angle along the E-plane of an array of eight antenna elements for three different frequencies;

FIG. 8 is a plot showing measured and simulated normalized radiation intensities as a function of frequency for a single antenna element and an array of eight antenna elements;

FIG. 9A is a plot showing a transient gain as a function of an angle along the H-plane for four antenna configurations;

FIG. 9B is a plot showing a transient gain as a function of an angle along the E-plane for four antenna configurations;

FIG. 10A is a plot showing a transient noise as a function of an angle along the H-plane for four antenna configurations;

FIG. 10B is a plot showing a transient noise as a function of an angle along the E-plane for four antenna configurations;

FIG. 11A shows a plot of a simulated transmitted signal by a single antenna element for different angles along the H-plane;

FIG. 11B shows a plot of a simulated transmitted signal by an array of eight antenna elements for different angles along the H-plane;

FIG. 12A shows a plot of a measured transmitted signal by a single antenna element for different angles along the H-plane;

FIG. 12B shows a plot of a measured transmitted signal by an array of eight antenna elements for different angles along the H-plane;

FIG. 13 shows a plot of the average voltage of a signal (i.e., pulse) reflected from a metal surface versus the distance of the antenna from the metal surface without the presence of a substance;

FIGS. 14A and 14B respectively show plots of a reflected signal for open stacked layers and metal wrapped layers using the antenna configuration of FIG. 14A;

FIGS. 15A and 15B respectively show plots of a reflected signals for open stacked layers and metal wrapped layers using the antenna configuration of FIG. 15B;

FIGS. 16A and 16B respectively show plots of a reflected signals for open stacked layers and metal wrapped layers using the antenna configuration of FIG. 16C;

FIG. 17 is a schematic representation an apparatus for evaluating one or more properties of a multilayer system in a tank;

FIG. 18 is a side view of an exemplary antenna comprising a single antenna element suitable for use with the apparatus of FIG. 17;

FIG. 19A is an axonometric view of an another exemplary antenna comprising eight of the antenna element of FIG. 18 arranged in an array configuration;

FIG. 19B is a photograph of the antenna of FIG. 19A where the antenna elements are operatively coupled together;

FIG. 19C is a schematic top view of the antenna of FIG. 19A;

FIG. 20 is a layer reflection diagram showing levels and dielectric properties of different layers in a multilayer system;

FIG. 21 is a flowchart illustrating an exemplary method for evaluating one or more properties of a multilayer system in a tank;

FIG. 22 is a flowchart illustrating an exemplary method associated with the method of FIG. 21 and performed using a processor of the apparatus of FIG. 17;

FIG. 23 is a flowchart illustrating an exemplary method for evaluating one or more properties of a two-layer system in a tank;

FIG. 24 is a flowchart illustrating an exemplary method for evaluating one or more properties of a multilayer system;

FIG. 25 is a photograph of an experimental multilayer system;

FIG. 26A is a photograph of an exemplary antenna comprising a single transmitting element and a single detecting element;

FIG. 26B is a photograph of another exemplary antenna comprising four transmitting elements and four detecting elements;

FIG. 26C is a photograph of another exemplary antenna comprising eight transmitting elements and two detecting elements;

FIG. 27 shows a plot of the average voltage of a signal (i.e., pulse) reflected from a metal surface versus the distance of the antenna from the metal surface without the presence of the multilayer system;

FIGS. 28A and 28B respectively show plots of reflected signal for open stacked layers and metal wrapped layers using the antenna configuration of FIG. 26A;

FIGS. 29A and 29B respectively show plots of reflected signals for open stacked layers and metal wrapped layers using the antenna configuration of FIG. 26B;

FIGS. 30A and 30B respectively show plots of reflected signals for open stacked layers and metal wrapped layers using the antenna configuration of FIG. 26C;

FIG. 31 shows a table of the expected values for permittivity and levels of different substances in the multilayer system of FIG. 25 together with the values measured using the antenna configurations of FIGS. 26A-26C; and

FIGS. 32A-32E are plots of the differences between the expected values for permittivity and levels of the different substances in the multilayer system of FIG. 25 and the values determined using the antenna configuration shown in FIG. 26C.

### DETAILED DESCRIPTION

The level sensor disclosed herein may be used in mobile tank gauging and/or stationary tank gauging applications. For example, the level sensor disclosed herein may be used in aviation, chemical, oil & gas, refined fuels and used oil applications for level gauging of substances in reservoirs/tanks such as, for example, aviation fuels, liquid chemicals and used oils. In various embodiments, the level sensor disclosed herein may be useful for measuring a level of a layer a substance. It may also be suitable for measuring a dielectric permittivity of the layer of the substance. Moreover, the level sensor disclosed herein may be suitable for measuring a level of a layer of a first substance superposed to one or more than one other(s) layer(s) of substance(s) in a multilayer system, for instance. It may further be useful for measuring parameters of layers underneath one or more layer of other substances.

Level measurement using antenna pulsed radar can be used with a wide range of frequencies to determine the distance between the liquid layers and the antenna. This type of measurement requires a relatively simple time-of-flight calculation and a comparison with some pulse reference. However, circumstances arise where the reflected radar signal comprises losses due to lossy media and undesirable reflections due to internal walls of a metallic tank in which the substance is disposed, for instance. Indeed, when the reflected radar has noise due to undesirable reflections and losses therein, it may be difficult to identify the reflected radar pulses within the reflected radar signal. Therefore, as disclosed herein, the level sensor reduces the energy which is propagated outside a signal path and therefore may provide a valuable improvement in the functionality of existing pulsed radar level sensors by expanding the range of applications for which such pulsed radar systems can be used.

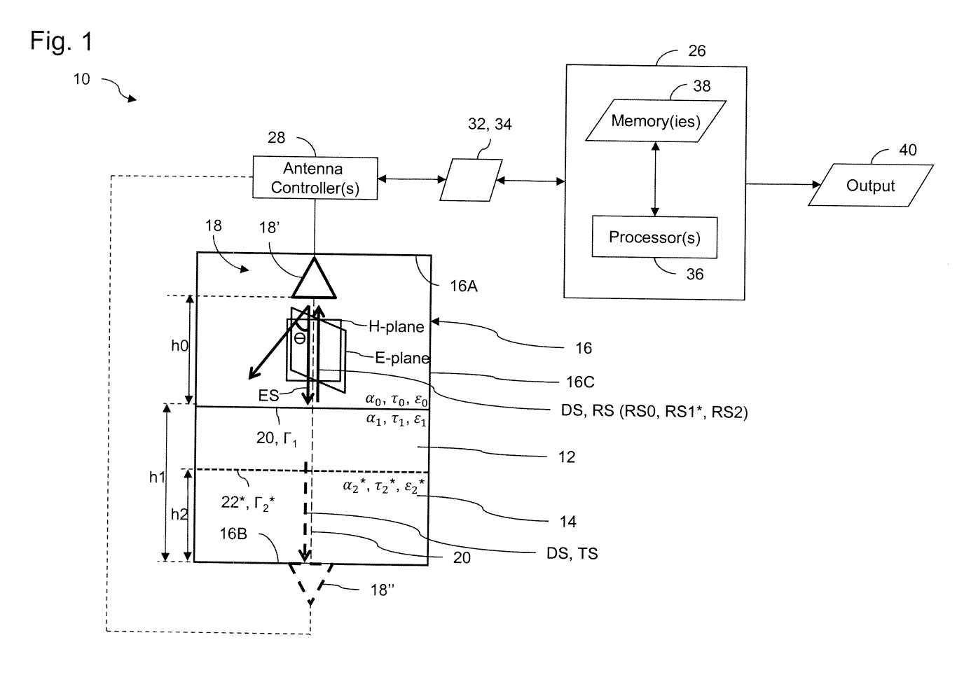

FIG. 1 is a schematic representation of a system 10 for measuring a thickness h1 of a first substance 12 (or thin layer thereof) in a tank 16 having sidewalls 16C. The system 10 may further be used to measure a first dielectric permittivity of the first substance 12. The tank 16 may comprise a mobile storage tank and/or a stationary storage tank and may be made of a reflective material such as metal, for instance. The first substance 12 may be a dielectric liquid or a dielectric solid or any suitable dielectric substance.

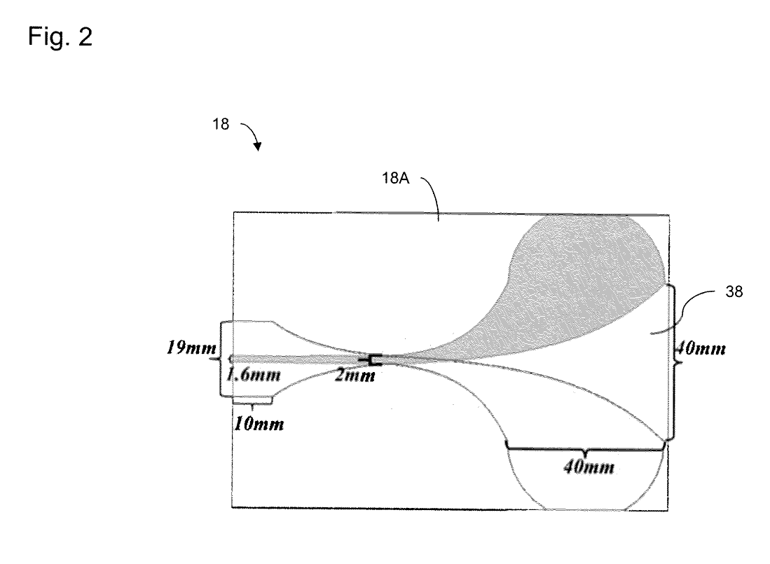

The system 10 comprises an antenna 18. The antenna 18 is made of at least one (emitting/receiving) array 18′ including at least two antenna elements 18A (shown in FIG. 2). The antenna 18 may be configured to emit a signal (referred hereinafter as “emitted radar signal ES”) comprising radiated electromagnetic energy toward the substance 12 along a signal path inside of the tank 16. The emitted radar signal ES may emit in a frequency range of 3.1-10.6 GHz, for instance, although it can emit it other ranges of frequencies as well. The antenna 18 may also be configured to detect radiated electromagnetic energy (referred hereinafter as “detected radar signal DS”) along the signal path 20. The emitted radar signal ES can be characterized as having characteristics along references planes known as the H-plane and E-plane for linearly polarized antennas. The H-plane and the E-plane are known in the art to be perpendicular to one another and are defined herein as having intersecting line along the signal path 20. In order to reduce undesirable reflections of the radar signal inside the tank 16, the arrays of antenna elements 18A are designed to increase a transient gain, and therefore, increase an energy density of the detected radar signal DS along the signal path 20. In other words, electromagnetic energy emitted along the signal path 20 may benefit from a higher gain than electromagnetic energy emitted along a direction having an angle Θ from the signal path 20.

In one embodiment, the emitting and receiving functions is carried out using a single array 18′ of antenna elements 18A wherein the detected radar signal DS corresponds to reflected electromagnetic energy (referred hereinafter as “reflected radar signal RS”). In this embodiment, the reflected radar signal RS has a combination of a plurality of signal components (e.g., patterns associated to pulses) identified herein as reflected radar signals RS0 and RS2. The reflected radar signal RS0 has a partial reflected radar signal representative of radiated electromagnetic energy reflected from the first substance 12 at a first interface 20 and detected using the antenna 18. The reflected radar signal RS2 has a partial reflected radar signal representative of radiated electromagnetic energy reflected from the bottom 16B of tank 16 and detected using the antenna 18. The antenna 18 is disposed near the top 16A of the tank 16 and above the uppermost level h0 of the substances. In other embodiments, the emitting and receiving functions may be carried out using two distinct arrays of antenna elements 18A. For instance, an emitting array 18′ for the emitting function can have eight antenna elements 18A while a receiving array for the receiving function (not shown) may comprise two antenna elements 18A.

In some other embodiments, separate emitting and receiving arrays 18′, 18″ of antenna elements 18A may be used instead of a single emitting/receiving array 18′ of antenna 18. In such situations, the detected radar signal DS may be transmitted electromagnetic energy (referred hereinafter as “transmitted radar signal TS”) and may be detected with receiving array 18″. As defined above, it is contemplated that the receiving array 18″ is part of the antenna 18. The antenna 18 may comprise one or more emitting arrays 18′ and one or more receiving arrays 18′, 18″. The antenna 18 may be disposed near the bottom 16B of the tank 16, although it can also be disposed at any other suitable location found fit for receiving the transmitted radar signal TS.

In another embodiment, the level sensor may be used to measure a second dielectric permittivity of a second substance 14 (see dashed line for interface 22*) in the event of a multilayer system inside tank 16. When more than one substance is provided in the tank 16 so as to form the multilayer system, the substances can be stacked or superposed inhomogeneously one to the other in the tank 16. For example, in a two-layer system stored inside tank 16, a first substance 12 (e.g., oil) may have a lower density than a second substance 14 (e.g., sludge, water) so that the first substance 12 may form an upper layer of the two-layer system and the second substance 14 may form a lower layer of the two-layer system. In this embodiment, optional reflected radar signal RS1* may comprise a second reflected radar signal representative of radiated electromagnetic energy reflected from the second substance 14 at a second interface 22 and detected using the antenna 18.

The system 10 may also comprise one or more computing devices or computers (referred hereinafter as “computing device 26”) operatively coupled to the antenna 18. For example, the computing device 26 may be coupled to the antenna 18 via one or more antenna controllers 28. The antenna controller(s) 28 may comprise circuitry configured to drive the antenna 18 to output a emitted signal ES in accordance with instructions 32 received from the computing device 26. The controller 28 may comprise circuitry configured to detect the detected radar signal DS. The instructions 32 may comprise one or more signals representative of a desired waveform, amplitude, frequency and duration for the emitted signal ES, and can be associated to an emitted pulse. The antenna controller(s) 28 may also comprise circuitry configured to convert the reflected radar signal RS (i.e., RS0, RS1*, RS2) or the transmitted radar signal TS into suitable form as input 34 for the computing device 26.

The computing device 26 may comprise one or more data processors 36 (referred hereinafter as “processor 36”) and one or more associated memories 38 (referred hereinafter as “memory 38”). The computing device 26 may comprise one or more digital computer(s) or other data processors and related accessories. The processor 36 may include suitably programmed or programmable logic circuits. The memory 38 may comprise any storage means (e.g. devices) suitable for retrievably storing machine-readable instructions executable by the processor 36. The memory 38 may comprise non-transitory computer readable medium. For example, the memory 38 may include erasable programmable read only memory (EPROM) and/or flash memory. The memory 38 may comprise, for example, but is not limited to, an electronic, magnetic, optical, electromagnetic, infrared, or semiconductor system, apparatus or device. Such machine-readable instructions stored in the memory 38 may cause the processor 36 to execute functions associated with various methods disclosed herein or part(s) thereof. The execution of such methods may result in the computing device 26 producing output 40. The output 40 may comprise data representative of one or more characteristics of the multilayer system. For example, the output 40 may comprise data representative of h0, h1, h2* (optional); one or more dielectric parameters ∈1, ∈2* (optional); temporal coordinates of pulse arrivals τ0, τ1, and τ2* (optional) and/or one or more dielectric loss tangents tan δ1, tan δ2* (optional) associated with the substances 12, 14 of the multilayer system. The output 40 may be directed to a display (not shown) or a printer so that the associated data may be presented to a user. Such display may be part of the system 10 or located remotely from the system 10. For example, the output 40 may be transmitted via wireless or wired connection to another terminal (not shown) located remotely from the system 10 and/or the tank 16.

FIG. 2 is a side view of an exemplary embodiment of the antenna 18 comprising a single antenna element 18A. The antenna 18 may comprise an ultra-wideband (UWB) antenna configured to operate in the frequency range from about 3.1 GHz to about 10.6 GHz. For the purposes of wideband pulsed radar there can be a limited number of choices that provide strong signal fidelity in the desired radiation direction, low ringing time and retain small radiated pulse width while also providing reasonable gain and constant radiation direction across the bandwidth of operation. These can include monocone, horn and Vivaldi antennas. It may be noted that such frequency range may be effective in detecting reflections from multiple material layers present in the multilayer system, for instance.

The non-limiting, exemplary type of antenna shown herein is a balanced antipodal Vivaldi-type antenna, but it is understood that other types of antennas could also be suitable in various applications. Such Vivaldi antennas may be produced relatively simply due to their planar configurations and may also be incorporated into arrays with relatively small overall dimensions. Non-limiting and exemplary dimensions for different parts of antenna 18 are also shown in FIG. 2. The antenna 18 of the Vivaldi type can have a stripline to tri-strip transmission line transition on a ROGERS 4003C (permittivity of 3.38 and tan δ of 0.0027@10 GHz) substrate. Flare end 38 of antenna element 18A may be curved to substantially prevent reflections or radiation that could otherwise occur from a discontinuous boundary. The width of the flare end 38 of antenna 18 may be relatively wide to provide a relatively good return loss, high transient gain and radiation efficiency at the lower end of the designed frequency range (i.e., 3.1-10.6 GHz). The requirements at low frequencies are the primary concerns in designing wideband antennas for high gain, and high transient gain. In some embodiments, the overall length may be around 11 cm long to provide sufficiently continuous transitions for the lowest frequencies.

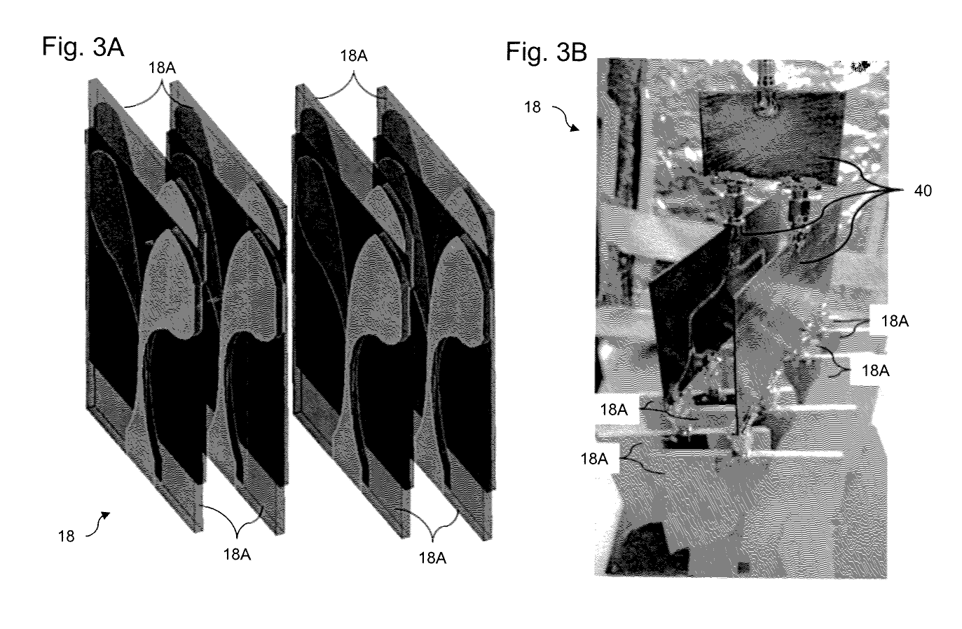

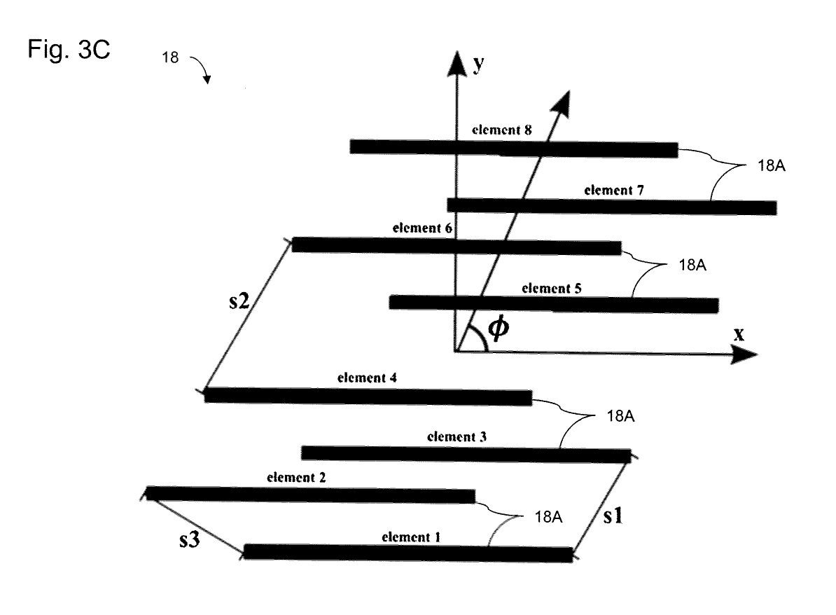

FIG. 3A is an axonometric view of another exemplary antenna 18 comprising an array of eight antenna elements 18A of FIG. 2 arranged in an array configuration. The 8-element array may be used with the intention of increasing the transient gain while having a relatively compact configuration. The antenna element 18A are planar and may be spaced by a spacing parameter in a linear configuration, or by more than one spacing parameter. In other embodiments, the spacing parameter may extend in a direction perpendicular to the signal path 20, for instance.

FIG. 3B is a photograph of antenna 18 of FIG. 3A where antenna elements 18A are operatively coupled together. Since the directivity should be highest in the direction of the signal path 20 of antenna 18, the antenna elements 18A of the array may be fed by one or more power dividers 40 designed with substantially equal phase and power division over the required bandwidth. Power dividers 40 may each be produced using a ROGERS 5880 (permittivity of 2.20 and tan δ of 0.0009@10 GHz) substrate.

FIG. 3C is a schematic top view of the antenna 18 of FIG. 3A comprising an array of eight antenna elements 18A of FIG. 2 arranged in an array configuration. The antenna elements 18A may be arranged in a 1-dimensional or a 2-dimensional array. For example, in a two dimensional array comprising 8 elements there may be three spacing parameters to vary; s1, s2 and s3 as shown in FIG. 3C. The two parameters s1 and s3 may be set to be equal to simplify the design and analysis.

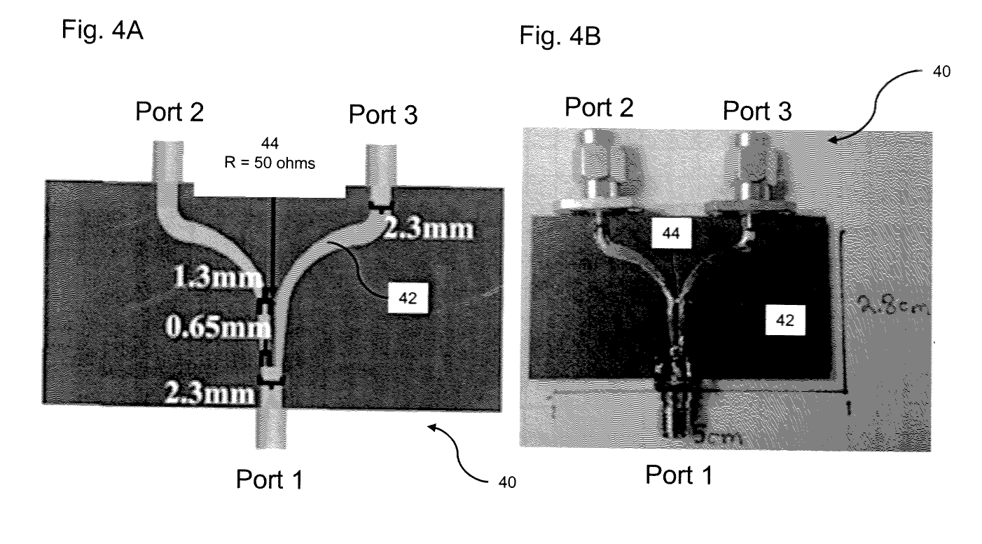

FIG. 4A is a schematic side view of the power divider 40 of FIG. 3B. The power divider 40 is used to operatively couple the antenna controller 28 to the antenna 18. As shown in FIG. 4B, the level sensor may have more than one power divider depending on the number of antenna elements in the antenna 18. More specifically, the power divider 40 may be provided as tapered transmission lines 42 since they are known to provide a high-bandwidth. The tapered transmission lines 42 further provides a shorter length for a power divider 40 being provided as a Wilkinson power divider. A resistor stage 44, e.g. 50 ohms, may be used since the tapered lines 42 provide suitable isolation and return loss performance. Moreover, the size and reduction of the return loss was found to be important.

FIG. 4B is a photograph of the power divider 40 of FIG. 4A. It is noted that the emitted radar pulse is to be propagated into Port 1 and further be divided relatively equally among Ports 2 and 3. The return loss S11 refers to the power detected at Port 1 when an electromagnetic signal is propagated into the same Port 1. Coupling losses or scattering parameters S12 or S13 refer to the power detected at Port 2 or Port 3 when an electromagnetic signal is propagated into the Port 1, for instance.

Simulation

In level measurement, the detected radar signal depend on the dielectric permittivity of the substance 12 (or other substances, i.e. the second substance 14, for instance) and the distance of the substance from the antenna 18. Substance measurements in the tank 16 may be hampered by sidewall reflections. For a tank 16 where the antenna 18 and the internal walls 16C are close, the emitted radar signal may take multiple paths other than the signal path 20 inside the substance in the tank 16 before being received by the antenna 18. The assumption of plane wave radiation that is often used in such circumstances may be no longer valid. Hence, employing an antenna array instead of a single antenna element may help to ameliorate or supress unwanted or undesirable reflections from the sidewalls. For a tank 16 where the antenna 18 and the internal walls 16C are sufficiently distanced from one another, the radiation apart from the signal path 20 may not be received by the antenna 18, or may occur at a much later time with significantly reduced amplitude, for instance. Therefore, there was a need for improving directionality of emission of the antenna 18 for reducing undesirable reflections when the internal walls 16 C are sufficiently close to the antenna 18.

In the simplest scenario, the additional reflections due to the reflections on the internal walls 16C may be misinterpreted as another layer with thickness Tr:

$${T}_{r} = \frac{{ct}_{delay}}{2 \sqrt{{ɛ}_{r}}} , \qquad Equation 1$$

where the t_{delay} is the time between the reflections off the sidewall and ∈ᵣ is the permittivity of the first layer (or substance). This may only affect subsequent layer height and permittivity estimations. However, if the reflections due to internal wall 16C interfere with the first reflection RS0, for instance, the estimation of ∈ᵣ may be erroneous. It may be difficult to compensate for this through signal processing since the position of the internal walls 16C depends on the tank and the time delay due to the internal walls 16C may be dependent on the level h0, for instance. Additionally, rather than being a single identifiable reflection, reflection due to internal sidewalls 16C may be a series of reflections contributed by all the radiation angles Θ interfering with complex time delay and amplitude relationships. Rather than dealing with chaotic and varying reflections due to internal walls 16C, it was found fit to use an antenna 18 as disclosed herein in order to enhance the transient gain and reduce low off-angle signal interference.

The antenna 18 has a frequency domain representation along the signal path 20, with the frequency proportionality of the emitting transfer function of the antenna 18 explicitly included, given by:

$$\frac{{U}_{{R}_{x}} ( f )}{\sqrt{{Z}_{C , {R}_{x}}}} = {H}_{{R}_{x}} ( f , {θ}_{{R}_{x}} , {φ}_{{R}_{x}} ) \cdot \frac{{e}^{j ω {r}_{{T}_{x} {r}_{x}} / {c}_{0}}}{2 π {r}_{{T}_{x} {R}_{x} {c}_{0}}} \cdot {H}_{{T}_{x}} ( f , {θ}_{{t}_{x}} , {φ}_{{T}_{x}} ) \cdot j ω \frac{{U}_{{T}_{x}} ( f )}{\sqrt{{Z}_{C , {T}_{x}}}} , \qquad Equation 2$$

where H_{R}_{ₓ}(ƒ, θ_{R}_{ₓ}, ψ_{R}_{ₓ}) is the transfer function of the receiving array of the antenna 18, H_{T}_{ₓ}(ƒ, θ_{T}_{ₓ}, ψ_{T}_{ₓ}) is the transfer function of the emitting array of the antenna 18, U_{T}_{ₓ}(ƒ) is the emitted radar signal ES and U_{R}_{ₓ}(ƒ) is the detected radar signal DS, Z_{C,R}_{ₓ} and Z_{C,T}_{ₓ} are characteristic impedances of the emitting and the receiving arrays of the antenna 18. For instance, Z_{C,R}_{ₓ} may be associated with the receiving array of the antenna 18, while Z_{C,T}_{ₓ} may be associated with the emitting array 18′ of the antenna 18. Performance of the emission of the antenna 18, the emitting electric fields are parameters of importance for characterization and are given by:

$${rE}_{{T}_{x}} ( f , {θ}_{{T}_{x}} , {φ}_{{T}_{x}} ) = \sqrt{{Z}_{0}} \cdot \frac{{e}^{j ω r / {c}_{0}}}{2 π {c}_{0}} \cdot {H}_{{T}_{x}} ( f , θ {T}_{x} , {φ}_{{T}_{x}} ) \cdot j ω \frac{{U}_{{T}_{x}} ( f )}{\sqrt{{Z}_{C , {T}_{x}}}} , \qquad Equation 3$$

where r E_{T}_{ₓ} (ƒ, r) is the electric field normalized to the distance from the transmitting antenna 18. This parameter may be directly extracted in simulation, however in measurement the effects of the receiving array of the antenna 18 may be removed to predict it. In anechoic chamber measurement, the receiving array of the antenna 18 may measure with the same angle to the transmitting antenna, i.e. both the receiving array of the antenna 18 and the emitting array of the antenna 18 are aligned along the signal path 20, thus yielding θ_{R}_{ₓ},

$${θ}_{{R}_{x}} , {ψ}_{{R}_{x}} = \{ {θ}_{{0}_{{R}_{x}}} , {ψ}_{{0}_{{R}_{x}}} \} .$$

The transfer function fo the receiving array of the antenna 18 may be extracted when measuring with two ideally identical antennas directly facing each other using Equation 4:

$${H}_{{R}_{x}} ( f , {θ}_{{0}_{{R}_{x}}} , {φ}_{{0}_{{R}_{x}}} ) = \sqrt{\frac{2 {S}_{21}}{( 1 + {S}_{11} ) ( 1 - {S}_{22} )} \frac{2 π {c}_{0} r}{j ω} {e}^{j ω r / {c}_{0}}} . \qquad Equation 4$$

Therefore, the transfer function of the emitting array of the antenna 18 may be calculated as:

$${H}_{{T}_{x}} ( f , {θ}_{{T}_{x}} , {φ}_{{T}_{x}} ) = \frac{{S}_{21} ( f )}{2 {e}^{j ω {r}_{{T}_{x} {R}_{x} / {c}_{0}}}} \frac{2 π {r}_{{T}_{x} {R}_{x}} {c}_{0}}{j ω {H}_{{R}_{x}} ( f , {θ}_{{0}_{{R}_{x}}} , {φ}_{{0}_{{R}_{x}}} )} \qquad Equation 5$$

The radiated field for a specified emitted radar signal ES may be specified as in Equation 3, where the form of U_{T}_{ₓ}(f) may be specified by an input pulse (emitted pulse by the emitting array of the antenna 18).

The radiation intensity energy of the emitted radar signal (i.e. pulse) may be given by:

$${U}_{E} ( {θ}_{{T}_{x}} , {φ}_{{T}_{x}} ) = \frac{1}{{η}_{0}} {\int }_{{t}_{1}}^{{t}_{2}} {\vert {\overline{E}}_{r ad} ( t , r , f , {θ}_{{T}_{x}} , {φ}_{{T}_{x}} ) \vert}^{2} {r}^{2} dt , \qquad Equation 6$$

The correlated energy pattern may be another way for measuring the performance of the antenna 18, and may be given as:

$${U}_{C} ( {θ}_{{T}_{x}} , {φ}_{{T}_{x}} ) = \frac{{max}_{τ} {\int }_{- ∞}^{∞} {\overline{E}}_{r ad} ( t - τ , r , f , {θ}_{{T}_{x}} , {φ}_{{T}_{x}} ) \cdot a ( {θ}_{{T}_{x}} , {φ}_{{T}_{x}} ) T ( t ) {rdt}^{2} }{{η}_{0} {\int }_{- ∞}^{∞} {\vert T ( t ) \vert}^{2} dt } , \qquad Equation 7$$

where α(θ_{T}_{ₓ}, φ_{T}_{ₓ}) is a unit vector expressing the polarization of the emitting array of the antenna 18, T(t) is a target signal and the electric field is understood to be a possibly distorted version of the target signal with time shift τ. This function is essentially the covariance of the distorted signal normalized to the energy of the target signal, and compared to Equation 5, may take into account the fidelity of the emitted radar signal. The normalization of the latter equation is referred to as a correlation coefficient of the emitted radar signal and is given by:

$$ρ ( {θ}_{{T}_{x}} , {φ}_{{T}_{x}} ) = \frac{{max}_{τ} {\int }_{- ∞}^{∞} {\overline{E}}_{r ad} ( t - τ , r , f , {θ}_{{T}_{x}} , {φ}_{{T}_{x}} ) \cdot a ( {θ}_{{T}_{x}} , {φ}_{{T}_{x}} ) T ( t ) {rdt}^{2} }{{{\int }_{- ∞}^{∞} {\vert T ( t ) \vert}^{2} dt {\int }_{- ∞}^{∞} {\overline{\vert E}}_{r ad} ( t - τ , r , f , {θ}_{{T}_{x}} , {φ}_{{T}_{x}} ) \vert}^{2} {r}^{2} dt} , \qquad Equation 8$$

which may be the ratio of energy in the emitted radar signal correlated to the target signal normalized by the energy in the emitted radar signal. The maximum thereof may be taken for the covariance of the time shifted signal since it is possible for there to be parts of the emitted radar signal that have high correlation with the target signal, however low energy.

For an uniformly excited array of antenna elements 18 A, the radiated electric fields can be calculated from the electric fields be first finding the time shift between the radiated fields as:

τₙ=c| [symbol] (θ_{T}_{ₓ},φ_{T}_{ₓ})·rₙ|, Equation 1

where rₙ is the coordinates of the nth antenna in relation to a first antenna array. The radiated transient electric fields of the array may be:

Ē_{array}(t,T,ƒ,θ_{T}_{ₓ},φ_{T}_{ₓ})=Σₙ₌ᵢⁿĒ_{single}(t−τⱼ,r,ƒ,θ_{T}_{ₓ},φ_{T}_{ₓ}), Equation 2

### Measurements and Examples

The return loss and coupling parameters of the antennas can be directly measured with a VNA. The frequency and transient characteristics of the antenna 18 are measured with transmission measurements in an anechoic chamber and the transient transmission is also measured with an oscilloscope. The anechoic chamber used can be any chamber which absorb reflections of electromagnetic waves so that isolation from an external environment is achieved. In the measurement setup, the emitting array of the antenna 18 is emitting along of a linear signal path while the receiving array of the antenna 18 is located at another end of the linear signal path for measuring the transmitted radar signal TS. The antenna 18 used for the measurements included an emitting array of eight antenna elements 18A and a receiving antenna element 18A for detecting the emitted radar signal.

The pulse provided as emitted radar signal in the emitting array of the antenna 18 was generated using an antenna controller 28 provided in the form of an arbitrary waveform generator (AWG) 70001A from Tektronix. The pulse profile was a Gaussian pulse with 3-10 GHz bandwidth; where the amplitude of the pulse reaches one-tenth of the maximum at 6.5 GHz. The width of the pulse is approximately 500 ps and excitation amplitude of the pulse is 200 mVpp. The pulse is amplified with a Giga-tronics GT-102A wideband high-power amplifier to a voltage between 5-8 Vpp. The antenna controller 28 further include a MSO72004C oscilloscope with 20 GHz bandwidth and an average of 1000 pulses trigged by the second output of the pulse generator for receiving the transmitted radar signal. The repetition time of the pulse was set to 16 ns since the reflections and transmission has decayed by this time. The repetition time and the number of averaging can be changed significantly with similar results.

Comparisons Between Simulation and Measurements

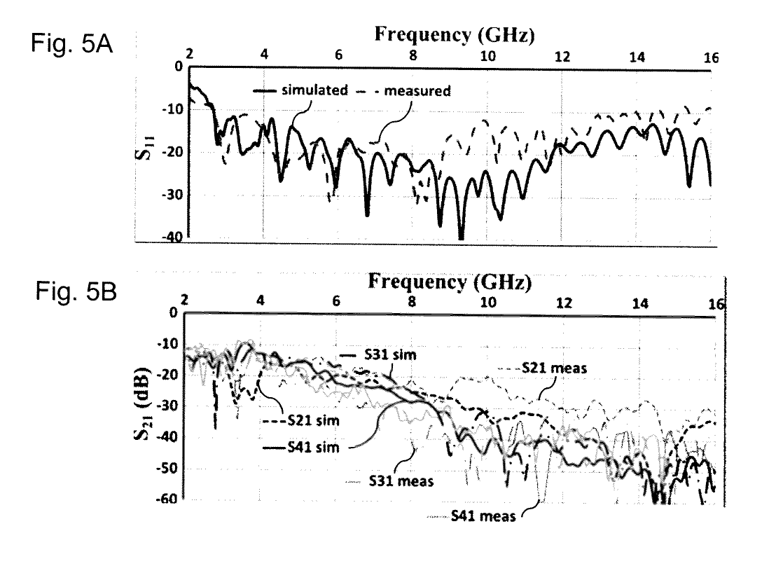

FIG. 5A is a graph showing simulated (solid line) and measured (dashed line) return losses of the power divider 40 of FIG. 4 for a frequency range ranging from 2 GHz to 16 GHz.

FIG. 5B is a graph showing simulated (solid line) and measured (dashed line) scattering parameters S21, S31 of the power divider 40 of FIG. 4 for a frequency range ranging from 2 GHz to 16 GHz. It is noted that S11 and S21 remains below −10 dB for the frequency range and S21 is lower than −15 dB after about 6 GHz.

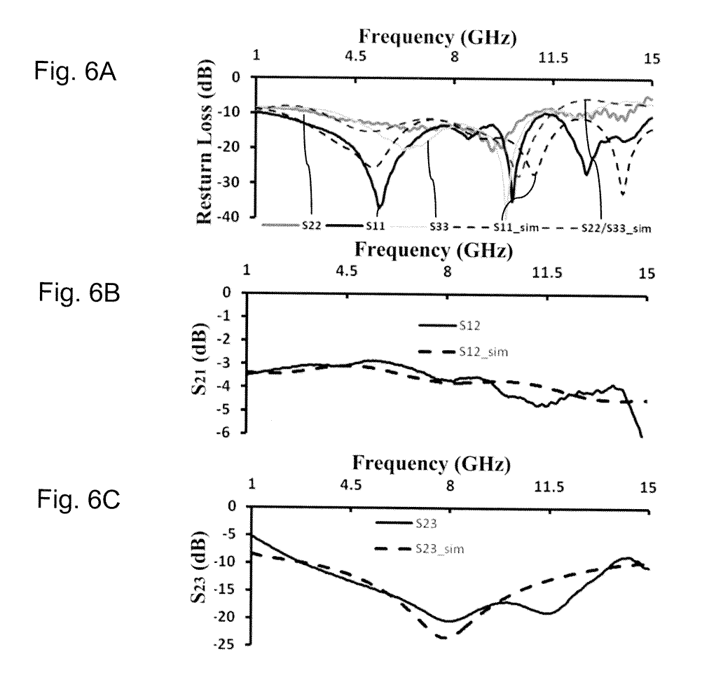

FIG. 6A shows a plot of simulated and measured return losses as a function of frequency for the power divider 40 of FIG. 4B. FIG. 6B shows a plot of simulated and measured scattering parameter (S21) as a function of frequency for the power divider 40 of FIG. 4B. FIG. 6C shows a plot of simulated and measured scattering parameter (S23) as a function of frequency for the power divider 40 of FIG. 4B. The return loss and the coupling losses are better than 10 dB across the bandwidth, while the predicted transmission is greater than 4 dB (less that 1 dB insertion loss). The insertion loss at higher frequencies may be reduced by decreasing the transmission line lengths, however the return loss may suffer at the lower frequencies. Additionally, stripline transmission lines 42 may improve the insertion loss, but be harder to implement. For pulsed ultra-wideband (UWB) radar, the return loss and the coupling losses at the output ports are less primordial, thus these design considerations may be relaxed in favor of better insertion loss performance

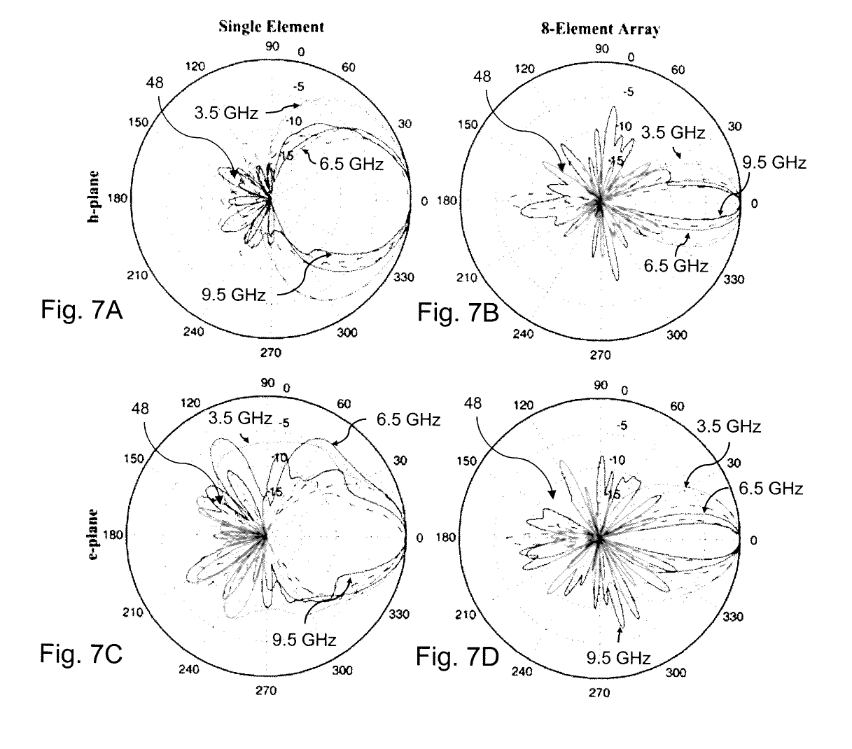

FIG. 7A-7D show plots of measured (dashed lines) and simulated (solid lines) gains as a function of angle along either the H-plane or the E-plane, for either a single antenna element or an array of eight antenna elements 18A for three different frequencies. These It is noticed that using an array of antenna elements 18A improves a bandwidth and gain thereof. In other words, the emitted radar signal is more focused along a signal path extending along the axis Θ=0. It is further noticed that, in practice, backlobes 48 may be removed using a free-space absorber (not shown) and thus only the patterns of the gain functions in the front 180° are to be considered. Additional lobes at 9.5 GHz have been found in measured patterns (dashed lines), thus not present in the simulation, which are likely due to holders of the antenna 18 and to the power dividers used in the anechoic chamber.

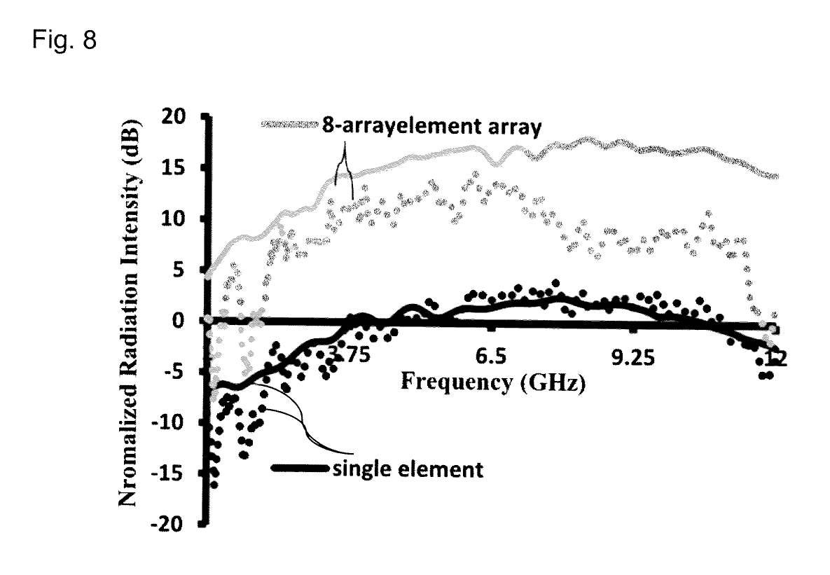

FIG. 8 is a plot showing measured and simulated normalized radiation intensities as a function of frequency for a single antenna element and an array of eight antenna elements. The simulated data stem from equations 3, 4, and 5. The simulated fields are normalized to the average over the frequency range of the single antenna element 18A so comparison can be made between the quantities which may not be referenced to the same input power. The shape of the simulated and measured normalized radiation intensities for the single antenna element are similar. The measured normalized radiation intensities of the array of eight antenna elements are comparable and tend to decrease with frequency. This may be attributed to the insertion loss of the power divider 40 of FIG. 3B which increases with frequency. Overall the transmitted fields are suitably flat within the frequency range of 3.1-10.6 GHz, which was found suitable.

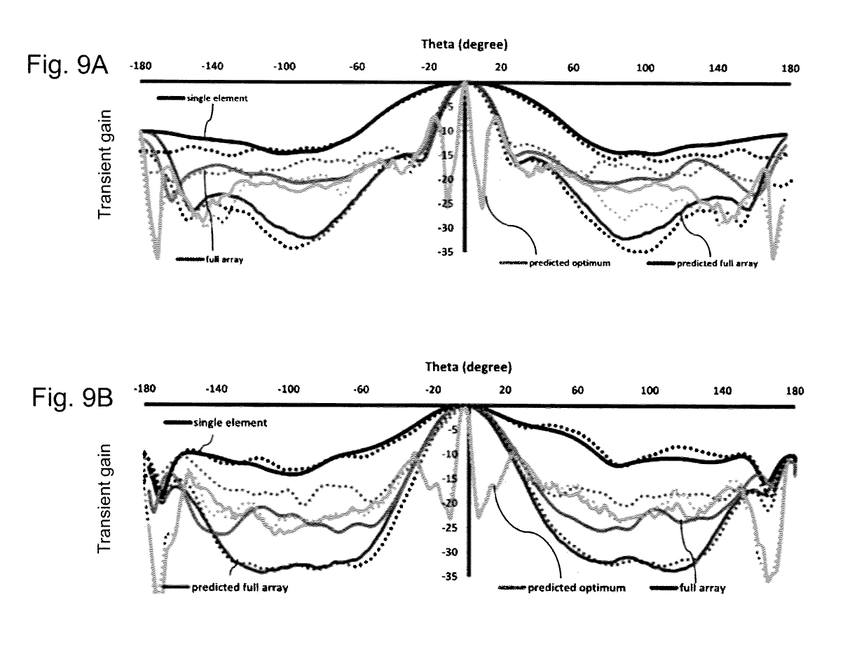

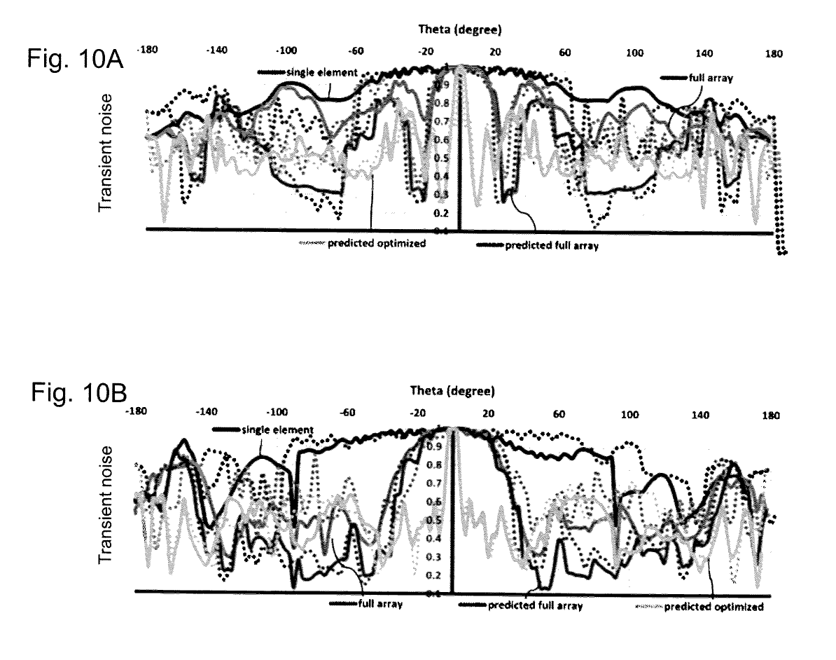

FIGS. 9 and 10 are plots showing, respectively simulated (solid lines) and measured (dotted lines) transient gain and transient signal noise as a function of an angle along either the H-plane or the E-plane for four different antenna configurations. The four different antenna configurations are: i) a single antenna element, ii) an array of eight-antenna elements 18A, iii) a time-shifted single antenna element and i) a time-shifted array of eight-antenna elements 18A. The time-shift of the configurations iii) and iv) compensate for possible distorted version of the target signal with time shift r, as described above. The simulated transient gain was calculated using the Equation 6 while the simulated transient signal noise was calculated using the Equation 8. Referring to FIGS. 9A and 9B, the measured 10 dB transient gain beam width of the single antenna and the array is 130° and 50° in the E-plane, and 116° and 48° in the H-plane, respectively. For the transient gain of the array with antenna elements 18A spaced apart (s1 and s3 equal 20 cm), the beam width is improved, however the predicted performance tend to be equal or worse than outside of the 10 dB beam width compared to current array. Both in simulation and measurement, the transient gain matches the time-shift prediction fairly closely ±45 degrees off the main beam, but the time-shift prediction doesn't take into account the coupling between elements, or more importantly for closely spaced elements, the shielding and scattering effects the presence of the antennas cause. Referring to FIGS. 10A and 10B, the target signal is time gated to 1 ns to capture the main pulse. Compared to the single antenna element configuration, the signal has a relatively high correlation up to 90° off the main beam, the signal correlation of the array is highly variable. For pulse identification algorithms that are useful in the analysis of reflected pulses, a low correlation of off angle radiation may be advantageous. Additionally, the interference of radiation from many different directions will now add together more like noise rather than related signals.

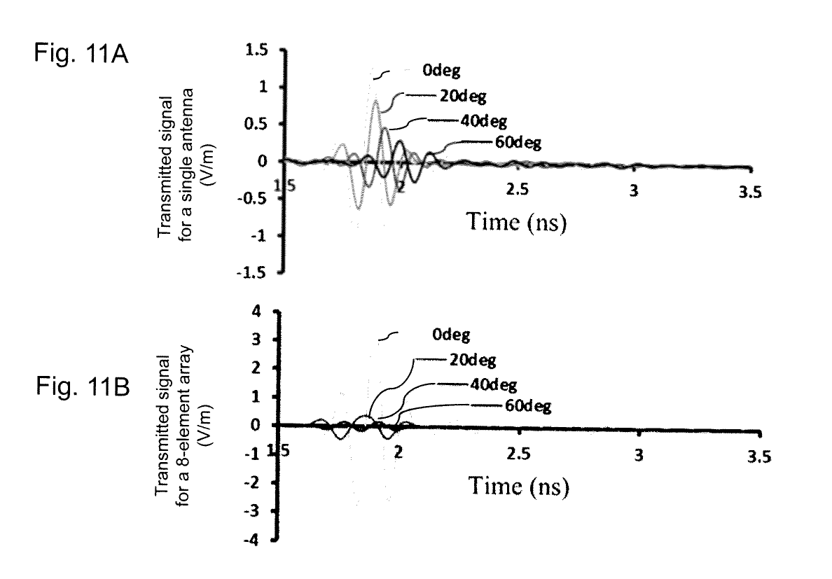

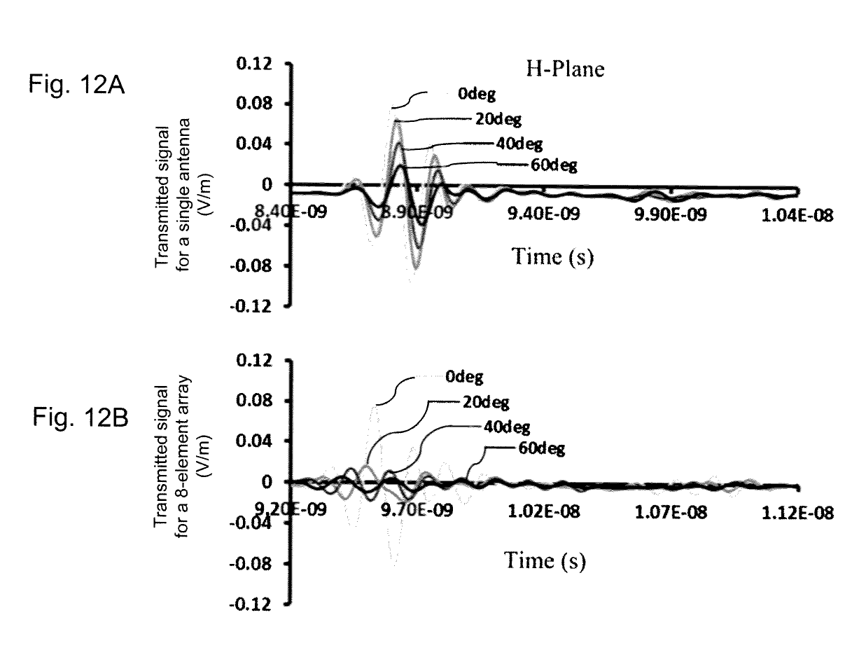

The consequences of increasing the transient gain is that signals reflected from the internal walls 16C may be reduced in amplitude and also distorted so that the transmitted signal from multiple angles may not combine in phase. Accordingly, FIGS. 11A-12B show plots of a simulated and measured transmitted signal by either a single antenna element or an array of eight antenna elements for different angles along the H-plane. It is seen that the undesirable reflected radar signals emitted along a signal path which differs from the signal path 20 at Θ=0 are reduced for an array of eight antenna elements 18A both in the simulated and in the measured transmitted signal. The measured transmitted signals was received a single antenna element from different angles upon excitation of the single antenna element and the array of eight antenna element with a 3-10 GHz Gaussian pulse using the AWG. The emitting and receiving elements were separated by 60 cm. It is noted that the simulated values concord with the measured values.

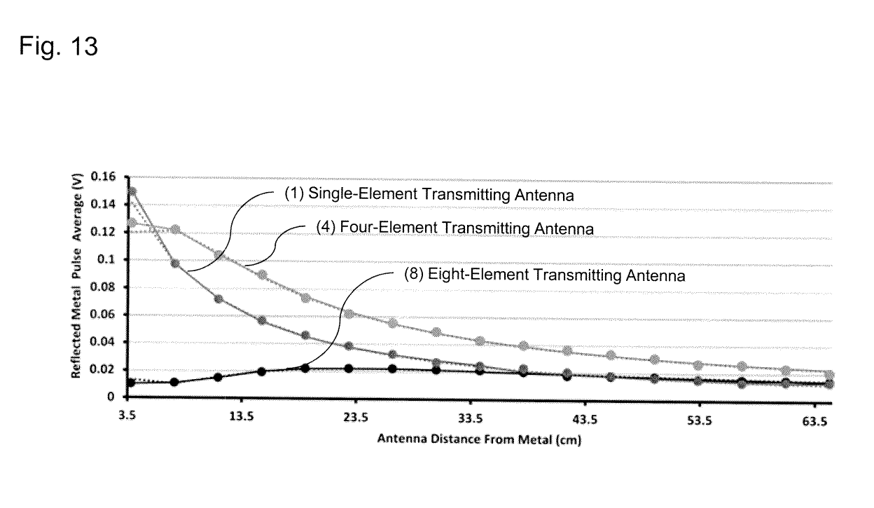

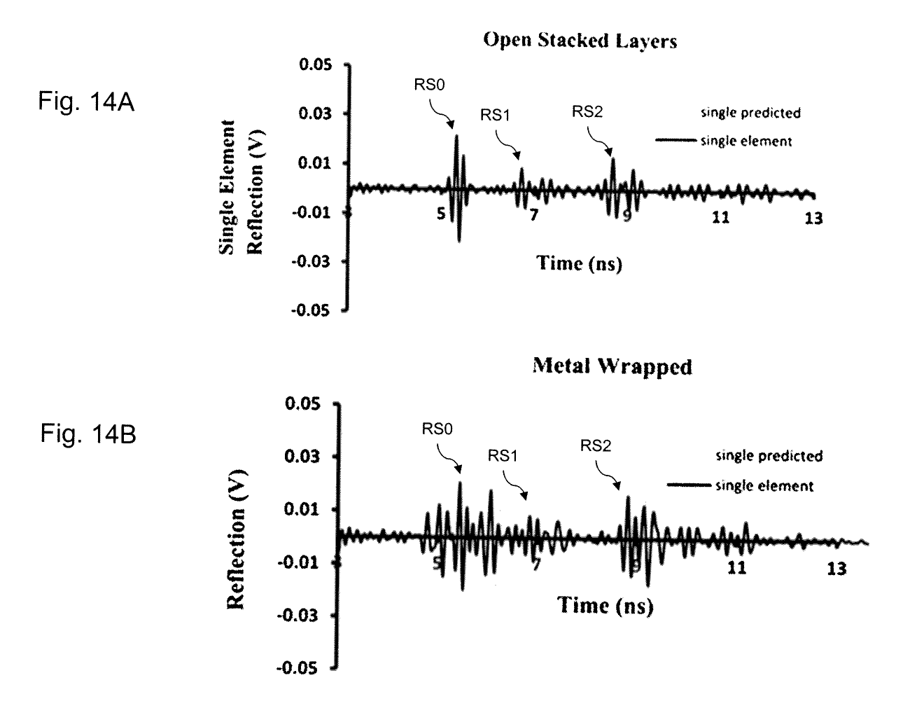

FIG. 13 shows a plot of the average voltage of a signal (i.e., pulse) reflected from a metal backing (not shown) versus the distance of antenna 18 from metal backing 50 without the presence of a substance 12. The average voltage is representative of a detected baseline reflected signal (BRS) without the substance 12 (i.e., representing an empty tank). The information on the plot of FIG. 13 may be obtained during a calibration procedure, stored and used later during measurement to determine the amount of power that is dissipated in the substance 12 versus distance. Such voltage may be obtained from the BRS as described above and may be acquired for the purpose of obtaining system characteristics of the antenna 18 at various distances from the metal backing, which may be analogous to the bottom wall 16B of tank 16. Information such as the information provided in FIG. 13 can be stored in calibration data for use by the computing device 26, for instance. The computing device 26 can be adapted to determine information pertaining to the reflected pulse amplitude versus distance and to correct the reflected pulse based on the calibration data. Indeed, the calibration data can be used for determining a distance of a reflection based on a temporal coordinate thereof and attribute a distance and a transmission loss of the reflected pulse based on the calibration data, for instance. In other words, the computing device 26 can be adapted to i) identify a temporal coordinate of a reflected pulse; ii)_attribute a distance and a transmission loss to the reflected pulse based on calibration data; and iii) determine the parameter based on the distance, on the transmission loss and on the calibration data. The calibration data can be different for an antenna having an array of eight antenna elements than with an antenna having a single antenna element. Indeed, a reflected pulse amplitude of an antenna having with a single antenna element typically has an 1/r (inverse of distance) relationship while the reflected pulse amplitude of an antenna having eight antenna elements can have another relationship (see FIG. 13). Accordingly, the calibration data can be provided in the form of a 1/r formula in the case of a single antenna element, whereas it can be provided in the form of a table or a more complex formula in the case of an array. The calibration data can be obtained beforehand, such as by measuring the reflected pulse amplitude as a function of distance during a calibration step, to establish the exact table or formula.

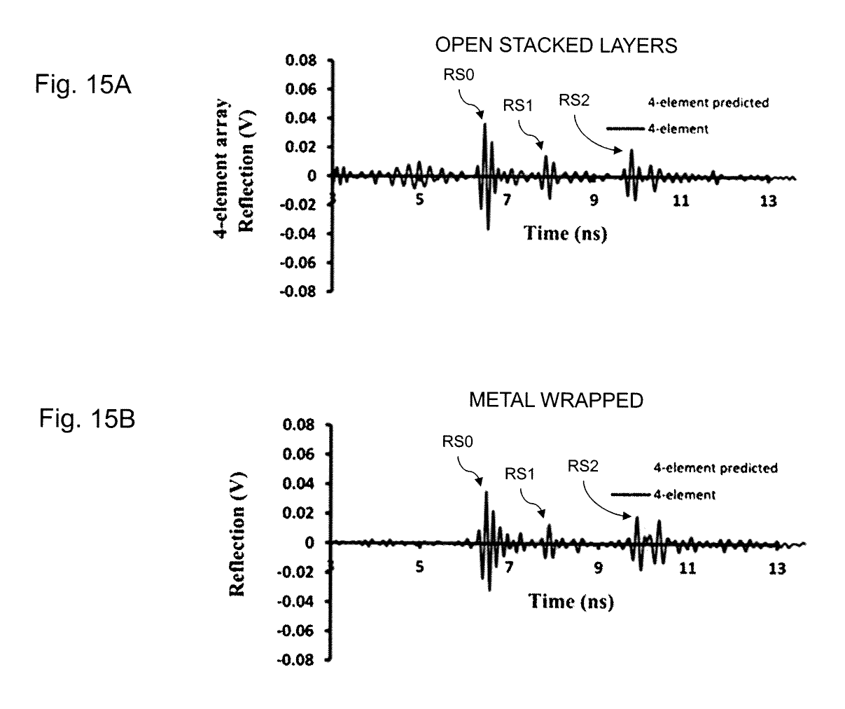

FIGS. 14A-16B show plots of reflected signal RS expressed as voltage versus time for open stacked layers where the first substance 12 is superposed to a second substance 14. The tank used is not metallic, i.e. open stacked (therefore less undesirable reflections), it was therefore metal wrapped to mimic a metallic tank. FIGS. 14A-16B show simulated and measured detected signals for different configurations of antennas. The different components (i.e., reflected pulses) of interest in the detected radar signal DS are identified on the plots as first reflected signal RS0, second reflected signal RS1 and third reflected signal RS2. In this particular experiment, the reflection data for the three different antenna configurations was acquired with the antennas positioned 39.6±0.2 cm above the second substance 14. Predicted reflection data was determined based on the pre-determined (e.g., obtained by other methods) layer heights and permittivity values and is also plotted in stippled lines to show the difference between the acquired data and the predicted reflection data. It is seen that the reflected signals RS0, RS1 and RS2 are less noisy when using an array of antenna elements than when using a single antenna element.

In another aspect, the methods and apparatus disclosed herein may be used in mobile tank gauging and/or stationary tank gauging applications. For example, the methods and apparatus disclosed herein may be used in aviation, chemical, oil & gas, refined fuels and used oil applications for level gauging of substances such as, for example, aviation fuels, liquid chemicals and used oils. In various embodiments, the apparatus and methods disclosed herein may be useful for measuring thicknesses of a plurality of stacked substances defining a multilayer system. For example, such multilayer system may comprise a first substance (layer) over a second substance (layer) in a storage tank where the first substance has a different permittivity than the second substance. Such first and second substances may, for example, comprise liquids of different densities.

Liquid level measurement using antenna pulsed radar can be used with a wide range of frequencies to determine the distance between the liquid level and the antenna. This type of measurement requires a relatively simple time-of-flight calculation and a comparison with some time delay reference. As explained herein, the calculation of permittivity may allow for subsequent layer heights/thicknesses (i.e., in multilayer systems) to be determined and this may provide a valuable improvement in the functionality of existing pulsed radar liquid level measurement systems by expanding the range of applications for which such pulsed radar systems can be used.

In various embodiments, apparatus and methods described herein may use the same or similar data typically acquired with a pulsed radar system to characterise multi-layer systems including, for example, calculating the permittivities and layer thicknesses of the substances forming such systems. In some embodiments, some modifications may be made to the antennas and/or some other installation precautions may be considered reduce the amount and effects of spurious reflections (i.e., false echoes) of the radiated electromagnetic energy associated with the use of such systems with or inside tanks. In various embodiments, the determination of the permittivities and thicknesses may be made with or without the advance knowledge of the total tank height or the total height of the multilayer system. In some embodiments, the permittivities and thicknesses may be determined with reduced computational power in comparison with some existing methods.

In various embodiments, the apparatus and methods disclosed herein may be useful for determining the thicknesses and permittivities of the stacked substances (layers) while requiring computational resources and accuracy suitable for liquid level measurements in tanks. As explained below, the reflected pulses (signals) may be relatively accurately localized within the filtered reflected data. The effect of loss on the amplitude of reflections may be used in the analysis since typical materials stored in tanks can be lossy at the frequencies used.

In the present disclosure, an exemplary two-layer system is described since this represents a common situation that may be encountered in practice. However, the apparatus and methods disclosed herein may be used in other situations where additional layers or different materials than those disclosed herein are used. In some applications, the accuracy of the results obtained may decrease with the presence of additional substances/layers in the multilayer system. In some cases the knowledge of any of the material parameters being estimated can be used to improve the accuracy of the measurements obtained. For example, the knowledge of the total distance between the antenna and the bottom of the tank (i.e., total tank height) can be used to improve the accuracy of the measurements by eliminating the need for determining such value.

Aspects of various embodiments are described through reference to the drawings.

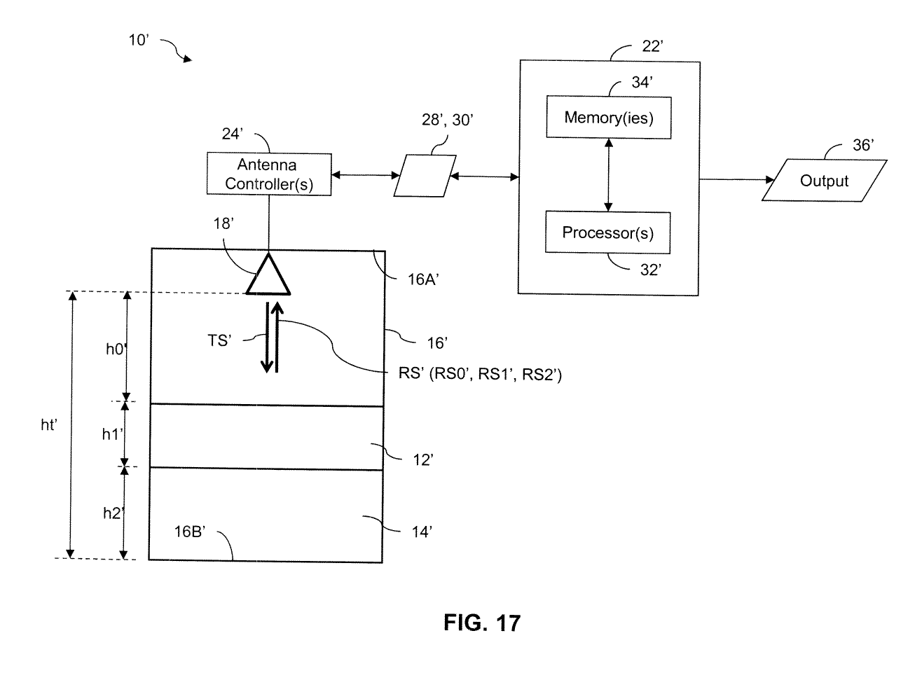

FIG. 17 is a schematic representation apparatus 10′ for evaluating one or more properties of a multilayer system in tank 16′ including measuring thickness h1′ of first substance 12′ and thickness h2′ of second substance 14′. In FIG. 17, thickness h0ζ may represent the thickness of the free space (e.g., air) between first substance 12′ and antenna 18′. In other words, h0′ may also represent the distance between antenna 18′ and first substance 12′ (i.e., first interface). Tank 16′ may comprise a mobile storage tank and/or a stationary storage tank. First substance 12′ and second substance 14′ may comprise liquids having different densities so as to form stacked layers inside tank 16′. For example, in a two-layer system stored inside tank 16′, first substance 12′ (e.g., oil) may have a lower density than second substance 14′ (e.g., sludge, water) so that first substance 12′ may form an upper layer of the two-layer system and second substance 14′ may form a lower layer of the two-layer system.

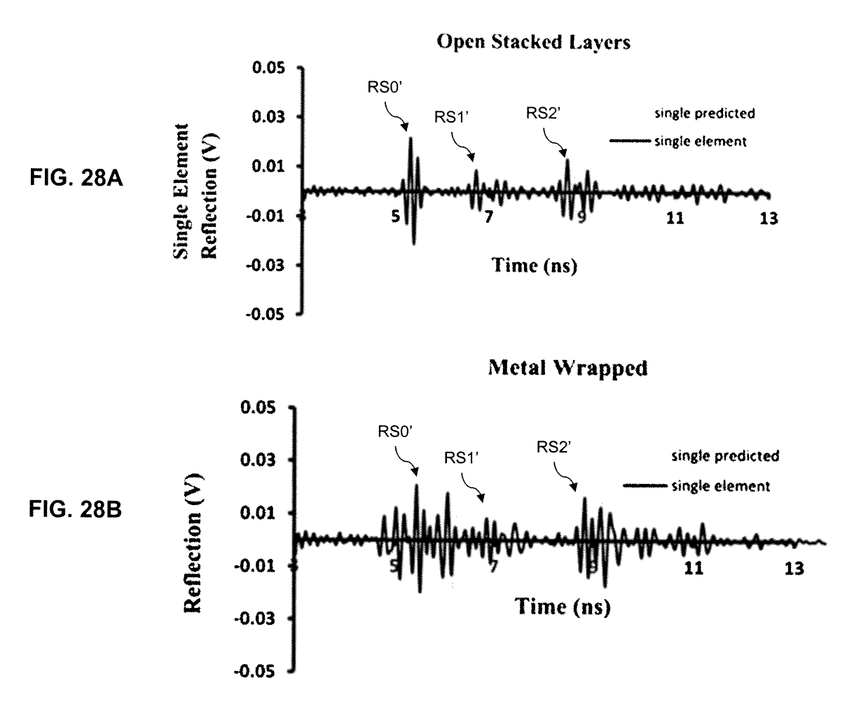

Apparatus 10′ may comprise one or more antennas 18′ (referred hereinafter as “antenna 18′”). Antenna 18′ may be configured to transmit one or more signals (referred hereinafter as “transmitted signal TS′”) comprising radiated electromagnetic energy toward the multilayer system (e.g., substances 12′, 14′) inside of tank 16′. Antenna 18′ may also be configured to detect radiated electromagnetic energy (referred hereinafter as “reflected signal RS”) reflected from the multi-layered system (e.g., substances 12′, 14′). Reflected signal RS′ may comprise a combination of a plurality signal components (e.g., pulses) of interest identified herein as reflected signals RS0′, RS1′ and RS2′ and shown in FIGS. 28A-30B. First reflected signal RS0′ may comprise a first reflected pulse representative of radiated electromagnetic energy reflected from first substance 12′ (i.e., first interface) and detected using antenna 18′. Second reflected signal RS1′ may comprise a second reflected pulse representative of radiated electromagnetic energy reflected from second substance 14′ (i.e., second interface) and detected using antenna 18′. Third reflected signal RS2′ may comprise a third reflected pulse representative of radiated electromagnetic energy reflected from the bottom wall 16B′ (i.e., third interface) of tank 16′ and detected using antenna 18′.

As shown in FIG. 17, the transmitting and detecting functions may be carried out using a single antenna 18′. However, in some embodiments, separate transmit and receive antennas may be used instead of a single antenna 18′. As explained further below, antenna 18′ may comprise one or more transmitting elements and one or more detecting elements respectively. Alternatively, antenna 18′ may comprise one or more antenna elements that are used for both transmitting and receiving. Antenna 18′ may be disposed near top wall 16A′ of tank 16′.

Apparatus 10′ may also comprise one or more computing devices or computers (referred hereinafter as “computing device 22′”) operatively coupled to antenna 18′. For example, computing device 22′ may be coupled to antenna 18′ via one or more antenna controllers 24′. Antenna controller(s) 24′ may comprise circuitry configured to drive antenna 18′ to output transmitted signal TS′ in accordance with instructions 28′ received from computing device 22′. Instructions 28′ may comprise one or more signals representative of a desired waveform, amplitude, frequency and duration for transmitted signal TS′. Antenna controller(s) 24′ may also comprise circuitry configured to convert reflected signal RS′ (i.e., RS0′, RS1′, RS2′) into suitable form as input 30′ for computing device 22′.

Computing device 22′ may comprise one or more data processors 32′ (referred hereinafter as “processor 32′”) and one or more associated memories 34′ (referred hereinafter as “memory 34′”). Computing device 22′ may comprise one or more digital computer(s) or other data processors and related accessories. Processor 32′ may include suitably programmed or programmable logic circuits. Memory 34′ may comprise any storage means (e.g. devices) suitable for retrievably storing machine-readable instructions executable by processor 32′. Memory 34′ may comprise non-transitory computer readable medium. For example, memory 34′ may include erasable programmable read only memory (EPROM) and/or flash memory. Memory 34′ may comprise, for example, but is not limited to, an electronic, magnetic, optical, electromagnetic, infrared, or semiconductor system, apparatus or device. Such machine-readable instructions stored in memory 34′ may cause processor 32′ to execute functions associated with various methods disclosed herein or part(s) thereof. The execution of such methods may result in computing device 22′ producing output 36′. Output 36′ may comprise data representative of one or more properties of the multilayer system. For example, output 36′ may comprise data representative of one or more thicknesses h1′, h2′; one or more relative permittivities ∈₁, ∈₂ and/or one or more dielectric loss tangents tan δ₁, tan δ₂ associated with substances 12′, 14′ of the multilayer system. Output 36′ may be directed to a display device (not shown) or a printer so that the associated data may be presented to a user. Such display device may be part of apparatus 10′ or located remotely from apparatus 10′. For example, output 36′ may be transmitted via wireless or wired connection to another terminal (not shown) located remotely from apparatus 10′ and/or tank 16′.

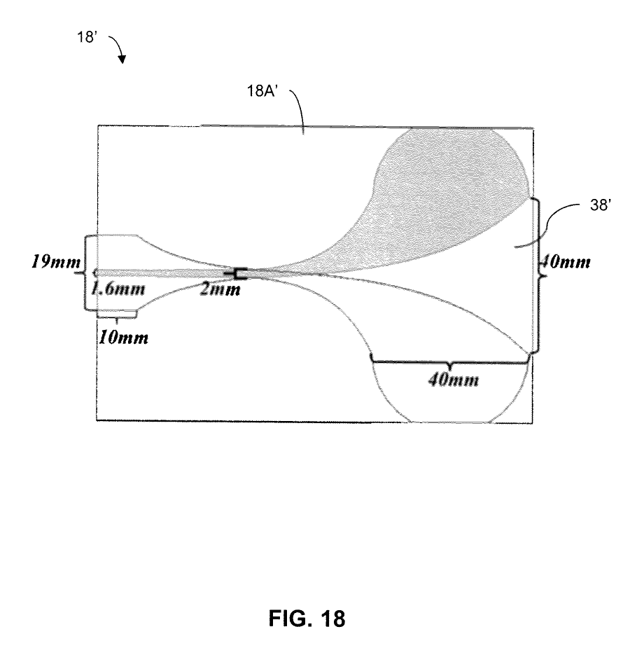

FIG. 18 is a side view of an exemplary embodiment of antenna 18′ comprising a single antenna element 18A′. Antenna 18′ may comprise an ultra-wideband antenna configured to operate in the frequency range from about 3.1 GHz to about 10.6 GHz. Such frequency range may be effective in detecting reflections from multiple material layers present in the multilayer system. For the purposes of wideband pulsed radar there can be a limited number of choices that provide strong signal fidelity in the desired radiation direction, low ringing time and retain small radiated pulse width while also providing reasonable gain and constant radiation direction across the bandwidth of operation. These can include monocone, horn and Vivaldi antennas.

The non-limiting, exemplary type of antenna shown herein is a balanced antipodal Vivaldi-type antenna, but it is understood that other types of antennas could also be suitable in various applications. Such Vivaldi antennas may be produced relatively simply due to their planar configurations and may also be incorporated into arrays with relatively small overall dimensions. Non-limiting and exemplary dimensions for different parts of antenna 18′ are also shown in FIG. 18. Antenna 18′ of the Vivaldi type may comprise a stripline to tri-strip transmission line transition on a ROGERS 4003C (relative permittivity of 3.38 and tan δ of 0.0027@10 GHz) substrate. Flare end 38′ of antenna element 18A′ may be curved to substantially prevent reflections or radiation that could otherwise occur from a discontinuous boundary. The width of flare end 38′ of antenna 18′ may be relatively wide to provide a relatively good return loss and radiation efficiency at the lower end of the designed frequency range (i.e., 3.1-10.6 GHz). The requirements at low frequencies are the primary concerns in designing wideband antennas for high gain. In some embodiments, the overall length may be around 11 cm long to provide sufficiently continuous transitions for the lowest frequencies.

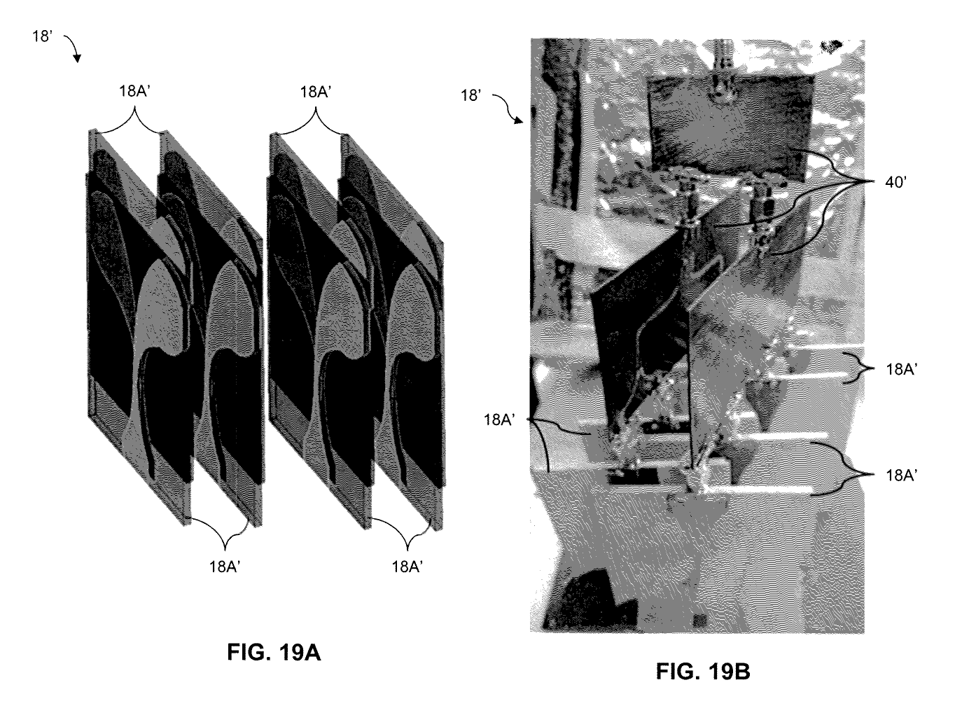

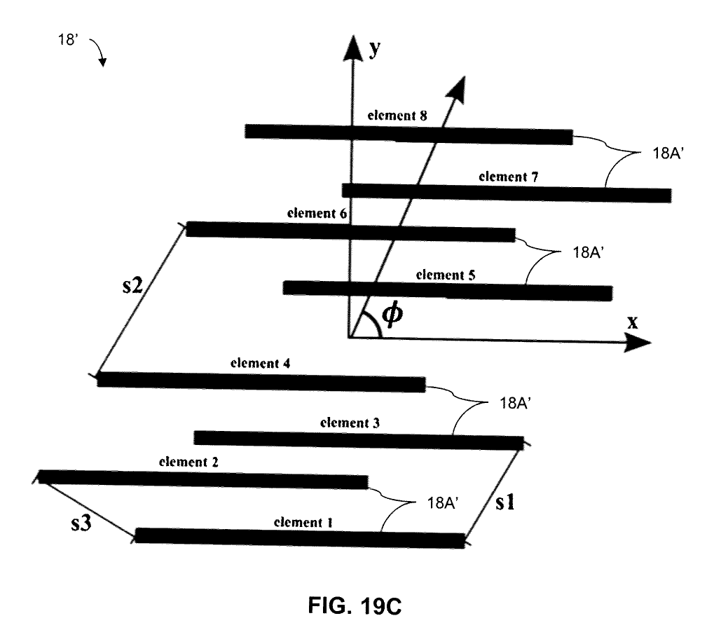

FIG. 19A is an axonometric view of another exemplary antenna 18′ comprising eight of antenna element 18A′ of FIG. 18 arranged in an array configuration. The 8-element array may be used with the intention of increasing the transient gain while having a relatively compact configuration.

FIG. 19B is a photograph of antenna 18′ of FIG. 19A where antenna elements 18A′ are operatively coupled together. Since the directivity should be highest in the main beam direction of antenna 18′, antenna elements 18A′ in the array may be fed by one or more power dividers 40′ designed with substantially equal phase and power division over the required bandwidth. Power dividers 40′ may each be produced using a ROGERS 5880 (relative permittivity of 2.20 and tan δ of 0.0009@10 GHz) substrate.

FIG. 19C is a schematic top view of antenna 18′ of FIG. 19A comprising eight of antenna element 18A′ of FIG. 18 arranged in an array configuration. Antenna elements may be arranged in a 1-dimensional or a 2-dimensional array. For example, in a two dimensional array comprising 8 elements there may be three spacing parameters to vary; s1, s2 and s3 as shown in FIG. 19C. The two parameters s1 and s3 may be set to be equal to simplify the design and analysis.

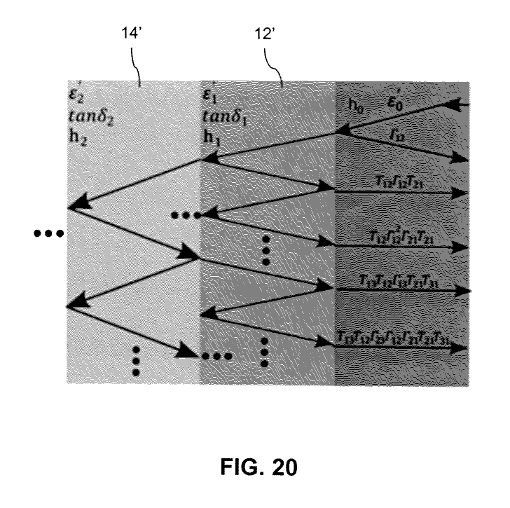

FIG. 20 is a layer reflection diagram showing thicknesses h0′, h1′, h2′ and dielectric properties such as permittivities ∈₁, ∈₂ and dielectric loss tangents tan δ₁, tan δ₂ of different layered substances 12′, 14′ in a multilayer system. In relation with the multilayer system shown in FIG. 17, the right most edge of FIG. 20 may represent the position of antenna 18′ and the left most edge of FIG. 20 may represent the wall (e.g., bottom wall 16B′) of tank 16′ of FIG. 17. The reflection diagram shows the first five reflections expected in a two-layer system together with the coefficients associated with those reflections.

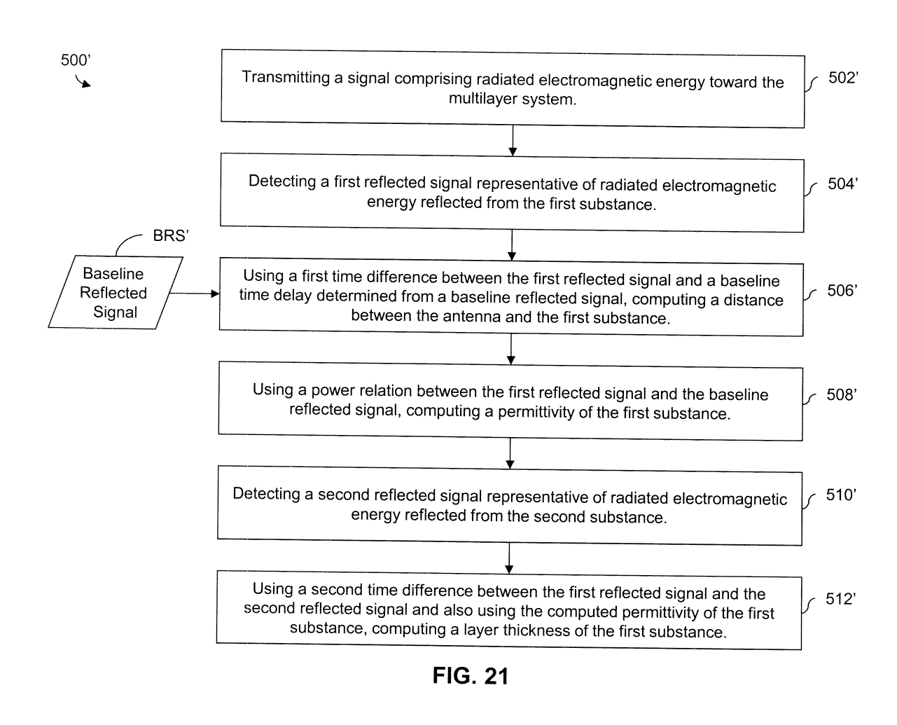

FIG. 21 is a flowchart illustrating an exemplary method 500′ for evaluating one or more properties of a multilayer system including measuring thickness h1′ of first substance 12′ and optionally thickness h2′ of second substance 14′ in the multilayer system in tank 16′. First substance 12′ may have a different permittivity than second substance 14′. As shown in FIG. 17, second substance 14′ may be disposed between first substance 12′ and bottom wall 16B′ of the tank 16′. Method 500′ or part(s) thereof may be performed using apparatus 10′. As mentioned above, apparatus 10′ may be used to evaluate properties of a multilayer system such as layered liquids stored in tank 16′. Such properties may include respective thicknesses of the multiple substances and also some dielectric properties of the substances.

In various embodiments, method 500′ may comprise: transmitting a signal TS′ comprising radiated electromagnetic energy toward the multilayer system (see block 502′); detecting a first reflected signal RS0′ representative of radiated electromagnetic energy reflected from first substance 12′ (see block 504′); using a first time difference between first reflected signal RS0′ and a baseline time delay determined from a baseline reflected signal BRS′, computing a distance h0′ between antenna 18′ and first substance 12′ (see block 506′); using a power relation (e.g. ratio) between first reflected signal RS0′ and baseline reflected signal BRS′, computing permittivity ∈₁ of first substance 12′ (see block 508′); detecting second reflected signal RS1′ representative of radiated electromagnetic energy reflected from second substance 14′ (see block 510′); using a second time difference between first reflected signal RS0′ and second reflected signal RS1′ and also using computed permittivity ∈₁ of first substance 12′, computing layer thickness h1′ of first substance 12′.

As explained below, in addition to thickness h1′ of first substance 12′, method 500′ described above may be modified to evaluate thickness h2′ of second substance 14′ and also other properties such as dielectric properties of the multilayer system shown in FIG. 17.

In some embodiments of method 500′, before acquiring reflected signal RS′ (e.g., RS0′, RS1′ and RS2′) and computing properties of the multilayer system, it may be desirable to perform a calibration of apparatus 10′ with or without tank 16′. Such calibration may be done to take into account system characteristics of antenna 18′ and tank 16′. For example, a calibration may include the transmission of transmitted signal TS′ using antenna 18′ and also the detection of baseline reflected signal BRS′ while tank 16′ is substantially empty so that free-space data may be acquired for the purpose of obtaining system characteristics of antenna 18′ together with tank 16′. Free space data may comprise electromagnetic energy that is transmitted directly between a transmitting element and a detecting element of antenna 18′ due to coupling and may need to be taken into account in the following computations.

As explained below, baseline reflected signal BRS′ may be used to characterise the baseline time delay associated with antenna 18′ with respect to the distance between antenna 18′ and bottom wall 16B′ of tank 16′. Baseline time delay may comprises a time period between the transmission of the transmitted signal TS′ and detection of a reflected signal (from baseline reflected signal BRS′) representative of radiated electromagnetic energy reflected from wall 16B′ of tank 16′ when tank 16′ is substantially empty. Baseline reflected signal BRS′ may also provide a baseline indication of the power reflected by bottom wall 16B′ of tank 16′ when tank 16′ is substantially empty and such value(s) may be used for later comparison for the purpose of evaluating power dissipation of electromagnetic energy into substances 12′, 14′ when such substances 12′, 14′ are present in tank 16′. Baseline reflected signal BRS′ may also be used to identify spurious reflections (i.e., false echoes) that may be associated with the transmitted signal TS′ interacting with the structure of tank 16′ so that such spurious reflections may be either filtered out from reflected signal RS′ or simply ignored during processing so that such spurious reflections may not be mistaken for reflected signals RS0′, RS1′ and RS2′. Accordingly, baseline reflected signal BRS′ may be stored in memory 34′ and used in subsequent measurements.

In some cases, apparatus 10′ may be calibrated prior to apparatus 10′ being delivered to the user and therefore without physical access to tank 16′. In such circumstances, the calibration may be conducted using a (e.g., metallic) plate or sheet having similar dielectric properties as bottom wall 16B′ of tank 16′ and also at a distance from antenna 18′ similar to the distance between bottom wall 16B′ and antenna 18′ in order to mimic the situation where antenna 18′ is installed with tank 16′. Accordingly, the calibration may be conducted without physical access to tank 16′ but under comparable conditions. Alternatively, the calibration could be conducted using another similar tank or on site.

Memory 34′ may comprise machine-readable instructions that may cause processor 32′ to control the performance of such calibration(s). In such case the user may instruct computing device 22′, via suitable user interface of computing device 22′, to perform such calibration after installation of apparatus 10′ with tank 16′ and the calibration may then be carried out substantially automatically or semi-automatically by apparatus 10′.

Baseline reflected signal BRS′ may be used to account for interference (i.e., free space data) from coupling between transmitting and receiving antennas 18′ if more than one antenna 18′ is used. For example, such interference may be accounted for by removing the free-space data in baseline reflected signal BRS′ from reflected signal RS′. Specifically, baseline reflected signal BRS′ may be acquired with an empty or substantially empty tank 16′ and may include the data taken only during the first few nanoseconds until the point where coupling and ringing has died away and ignoring the reflections that come from an empty tank 16′ farther away. Alternatively, the interference due to coupling between transmitting elements and detecting elements of antenna 18′ could be characterized using one or more detected signals other than baseline reflected signal BRS′ and not necessarily acquired in the presence of tank 16′.

In the case of a single antenna element 18A′ that both transmits and detects, there may not be a coupling issue as referenced above. Nevertheless, a similar calibration may be required to take into account ringing and any reflections from objects near antenna element 18A′.

The accumulated power reflected whether in baseline reflected signal BRS′ during calibration or in reflected signal RS′ during operation may be computed using Equation 1′ below

P_{α}(t)=∫₀^{t}r(t)²dt Equation 1′

where Γ(t) is the reflected data (i.e., BRS′ or RS′) and P_{α}(t) is the accumulated reflected power. To reduce the amount processing requirements, the calculation of accumulated reflected power may be deferred until after the data has been filtered and only done for where the reflections of interest (i.e., RS0′, RS1′, RS2′) have been identified in reflected signal RS′.

Quantifying the noise in reflected signal (BRS′ or RS′) may be useful for estimating the amount of power in reflected signal (BRS′ or RS′). The noise covariance may be estimated using the reflected data (BRS′ or RS′) in the first few nanoseconds where no reflected pulse has yet been detected or near the end where no reflected pulses would be expected. However, since the noise covariance would depend on the entire system itself, it could be characterised beforehand and stored as a single number value. The contribution of noise to the accumulated power may be quantified as the covariance of reflected amplitude or slope of the accumulated power. This contribution may be deducted from the accumulate power and multiplied by the pulse width.

In order to calculate the positions of the relevant signals RS0′, RS1′, and RS2′ (e.g., pulses) with respect to time in reflected data RS′, the derivative of the accumulated power data, or the absolute value of the reflected data RS′ may be median filtered using Equation 2′ below

$$peak = medfilt ( \frac{d}{2 dt} {\int }_{0}^{t} {Γ ( t )}^{2} dt ) = medfilt ( \vert Γ ( t ) \vert ) \qquad Equation {2}^{′}$$

and then the peaks may be located (based on maximum values and restricting to separations of one pulse width), leading to relatively accurate calculation of the reflected pulse centers. This may be used to identify reflected signals RS0′, RS1′ and RS2′ of interest in reflected signal RS′.

The determination of the permittivities may require relatively accurate prediction of the expected reflection power for different permittivities. Accordingly, the reflection amplitude with distance may be taken into account by fitting the measured reflection amplitude with distance from a metal surface (e.g., bottom wall 16B′ of tank 16′) to an equation that takes into account the path loss behaviour and relative gain and near field characteristics of the antennas/arrays 18′. The reflection amplitude with distance may be corrected with one of two equations, namely Equation 3′

$${Γ}_{metal} ( r ) = ( {k}_{1} ( {e}^{- {k}_{2} {r}^{{k}_{3}}} - 1 ) + \frac{{k}_{4}}{r} ) , \qquad Equation {3}^{′}$$

where kₙ are the fitting variables and r is the distance from the antenna; and Equation 4′ below

$${Γ}_{metal} ( r ) = \frac{{k}_{1}}{r} + \frac{{k}_{2}}{{r}^{2}} + \frac{{k}_{3}}{{r}^{3}} + \frac{{k}_{4}}{{r}^{4}} + \frac{{k}_{5}}{{r}^{5}} + \frac{{k}_{6}}{{r}^{6}} + \frac{{k}_{7}}{{r}^{7}} , \qquad Equation {4}^{′}$$

Either equation may be used since both converge to the inverse distance relation far from antenna 18′. Using Equations 3′ or 4′, the measured amplitudes from the reflection signal RS′ may then be calibrated using Equation 5′ below

$${Γ}_{corr} ( r ) = \frac{{A}_{meas} ( r ) {Γ}_{metal} ( {r}_{0} )}{{A}_{metal} ( {r}_{0} ) {Γ}_{metal} ( r )} , \qquad Equation {5}^{′}$$

where Aₘₑₐₛ(r) is the measured reflection amplitude, Aₘₑₜₐₗ(r₀) is the measured reflection from a metal surface at some distance r₀ (pre-stored, determined from baseline reflected signal BRS′). The time delay of antenna 18′ may also be calculated based on the known distance of the metal surface used for the calibration pulse and the reflected pulse time from the median filtered data (again determined from baseline reflected signal BRS′). Variables k₁₋₄ may characterize the antenna reflection amplitude equation.

Accordingly, the data that may be used for calibration and that may be derived from baseline reflected signal BRS′ and stored beforehand may include the time delay of the system (including antenna 18′ and tank 16′) and the reflected power expected for antenna 18′ being used with tank 16′. These may be characteristics of the system and may be stored in the variables contained in Equation 5′.

The measured amplitude of a reflected pulse may be determined from the accumulated power data using Equation 6′ below

$$A ( r ) = \sqrt{{P}_{a} ( {t}_{peak} + \frac{{t}_{width}}{2} ) - {P}_{a} ( {t}_{peak} - \frac{{t}_{width}}{2} )} \qquad Equation {6}^{′}$$

where t_{width} is the width of the pulse and tₚₑₐₖ is the center of the reflected pulse.

Referring again to method 500′, distance h0′ between antenna 18′ and first substance 12′ may be computed based on the reflected time in relation to the baseline time delay associated with antenna 18′ using Equation 7′ below

$${h}_{0} = \frac{c}{2} ( {t}_{1} - {t}_{delay} ) , \qquad Equation {7}^{′}$$

where c is the speed of light, t₁ is the time of the first pulse (i.e., first reflected signal RS0′) and t_{delay} is the time delay found from the metal calibration (i.e., from baseline reflected signal BRS′).

The relative permittivity E₁ of first substance 12′ may be found based on the change in the reflected power at the location of the peak locations in reflected signal RS0′ plus and minus half of the pulse width using

$$\frac{1}{\vert {η}_{1} \vert} = \frac{1}{\vert {η}_{0} \vert} \frac{1 + {Γ}_{corr}^{1} ( {h}_{0} )}{1 - {Γ}_{corr}^{1} ( {h}_{0} )} , \qquad Equation {8}^{′}$$

where

$$η = \frac{j ωμ}{{γ}_{i}}$$

and γᵢ=jω\sqrt{μ∈₀∈′ᵢ(1−j tan δ)=α+jβ}. It should be noted that in some of the equations herein, the real part ∈′₁ of the complex permittivity is specified for the computations.

The thickness h1′ of first substance 12′ may then be calculated from the difference in time to the second reflected pulse (i.e., the difference in time between first reflected signal RS0′ and second reflected signal RS1′) and the permittivity ∈₁ of first substance 12′ using Equation 9′ below

$${h}_{1} = \frac{c}{2 \sqrt{{ɛ}_{1}^{′}}} ( {t}_{2} - {t}_{1} ) , \qquad Equation {9}^{′}$$

As mentioned above, method 500′ may be modified to further determine thickness h2′ and one or more dielectric properties of the multilayer system. For example, based on the computed permittivity ∈₁ of first substance 12′, the dielectric loss tangent tan δ₁ of first substance 12′ may be computed, estimated or obtained from a look-up table. Such look-up table may be stored in memory 34′. Then, using dielectric loss tangent tan δ₁ of first substance 12′, permittivity ∈₂ of second substance 14′ may be computed using Equation 10′ below, which includes variables previously defined above

$$\frac{1}{\vert {η}_{2} \vert} = \frac{1}{\vert {η}_{1} \vert} \frac{1 + \frac{1}{{T}_{12} {T}_{21}} {Γ}_{corr}^{2} ( {h}_{0} + {h}_{1} ) {e}^{- 2 {α}_{1} {h}_{1}}}{1 - \frac{1}{{T}_{12} {T}_{21}} {Γ}_{corr}^{2} ( {h}_{0} + {h}_{1} ) {e}^{- 2 {α}_{1} {h}_{1}}} , \qquad Equation {10}^{′}$$

where

$${T}_{ij} = \frac{2 {η}_{i}}{{η}_{i} + {η}_{j}} .$$

The calculated permittivity ∈₂ of second substance 14′ may be hampered by the imprecise knowledge of the dielectric loss tangent tan δ₁ of first substance 12′ so it may be desirable to obtain dielectric loss tangent tan δ₁ from the look-up table based on the computed permittivity ∈₁. In some embodiments, the look-up table may also be used to identify first substance 12′ based on the computed permittivity ∈₁.

Method 500′ may also comprise detecting third reflected signal RS2′ representative of radiated electromagnetic energy reflected from bottom wall 16B′ of tank 16′ and using a third time difference (t₃−t₂) between second reflected signal RS1′ and third reflected signal RS2′ and also using the computed permittivity ∈₂ (i.e., see Equation 10′) of second substance 14′, computing a thickness h2′ of second substance 14′. Equation 11′ may be used when the total height ht′ of tank 16′ (i.e., the position of bottom wall 16B′ relative to antenna 18′) is unknown.

$${h}_{2} = \frac{c}{2 {\sqrt{{ɛ}_{2}^{′}}}^{′}} ( {t}_{3} - {t}_{2} ) . \qquad Equation 11$$

However, if the total height ht′ of the tank 16′ is known, method 500′ may comprise using total height ht′ of tank 16′, thickness h0′ of the space between antenna 18′ and first substance 12′ and thickness h1′ of first substance 12′ to compute a layer thickness h2′ of second substance 14′ using Equation 12′ below

h₂=hₜ−h₀−h₁ Equation 12′

where hₜ is the total height of tank 16′ measured from antenna 18′ to bottom wall 16B′ as shown in FIG. 17. Accordingly, if the total height ht′ of tank 16′ is known, Equation 12′ may be used instead of Equation 11′ to compute layer thickness h2′ of second substance 14′.

Also, if total height ht′ of tank 16′ is known, permittivity E₂ could be more accurately computed using Equation 13′ below

$${ɛ}_{2}^{′} = {( \frac{c}{2 {h}_{2}} ( {t}_{3} - {t}_{2} ) )}^{2} . \qquad Equation {13}^{′}$$

Accordingly, method 500′ may comprise detecting third reflected signal RS2′ representative of radiated electromagnetic energy reflected from bottom wall 16B′ of tank 16′; and using a third time difference (t₃−t₂) between second reflected signal RS1′ and the third reflected signal RS2′ and also the total height ht′ of tank 16′, computing a permittivity ∈₂ of second substance 14′. The use of Equation 13′ instead of Equation 10′ to compute permittivity ∈₂ could be more efficient and require less processing power.

Furthermore, the knowledge of the total height ht′ of tank 16′ may also permit the dielectric loss tangent tan δ₁ of first substance 12′ to be computed instead of obtained from the look-up table. Accordingly, method 500′ may comprise using the computed permittivity ∈₁ of first substance 12′, the computed permittivity ∈₂ of second substance 14′, the distance h0′ between antenna 18′ and first substance 12′, and, thickness h1′ of first substance 12′ to compute a dielectric loss tangent tan δ₁ of first substance 12′. For example, dielectric loss tangent tan δ₁ may be computed using Equation 14′ below, which contains variables previously defined above.

$${α}_{1} = - ln ( \frac{{Γ}_{corr}^{2} ( {h}_{0} + {h}_{1} )}{{T}_{12} {T}_{21} \frac{{η}_{2} - {η}_{1}}{{η}_{2} + {η}_{1}}} ) / 2 {h}_{1} \qquad Equation {14}^{′}$$

The loss in the reflected power may be accounted for if the substances can be identified and its dielectric loss can be obtained from the look-up table. Alternatively, the loss in the reflected power can be computed if the reflection pulse (i.e., reflected signal RS2′) of the bottom of tank 16′ is detectable. For example, if third reflected signal RS2′ is measurable, dielectric loss tangent tan δ₂ of second substance 14′ may be computed using Equation 15′ below

$${α}_{2} = - ln ( \frac{{Γ}_{corr}^{3} ( {h}_{0} + {h}_{1} + {h}_{2} )}{{e}^{- 2 {α}_{1} {h}_{1}} {T}_{12} {T}_{13} {T}_{12} {T}_{21} \frac{{η}_{3} - {η}_{2}}{{η}_{3} + {η}_{2}}} ) / 2 {h}_{2} \qquad Equation {15}^{′}$$

where η₃ would be −1 and Γ_{corr}³ would be 1 if bottom wall 16B′ of tank 16′ comprises a metallic material. Accordingly, method 500′ may comprise using the computed permittivity ∈₁ of first substance 12′, the computed permittivity ∈₂ of second substance 14′, distance h0′ between antenna 18′ and first substance 12′ and thickness h1′ of first substance 12′ and total height ht′ of tank 16′ to compute a dielectric loss tangent tan δ₂ of second substance 14′.

The equations presented above may be used in either a least squares fitting, an iterative technique and/or other known or other computational techniques on reflected signal RS′ that includes additional reflections (i.e., on systems having more than two layers and/or on reflected signals comprising overlapping and/or spurious reflections) using the reflected pulse shape, but could require additional data processing power and memory.

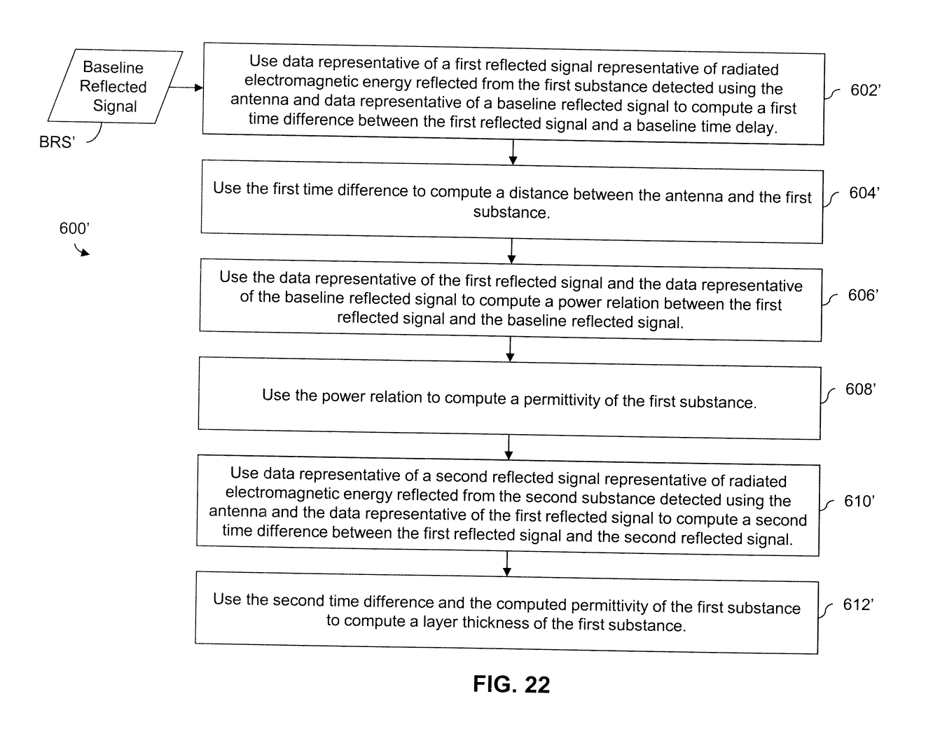

FIG. 22 is a flowchart illustrating an exemplary method 600′ associated with the method 500′ of FIG. 21 and performed using processor 32′ of apparatus 10′. As described above, apparatus 10′ may be used in the performance of method 500′ described above. Accordingly, method 600′ comprises tasks that may be performed by processor 32′ and that may be useful in the performance of method 500′ or part(s) thereof. Method 600′ may be performed based on machine-readable instructions that may be stored in memory 34′ and executable by processor 32′ and cause processor 32′ to: use data representative of first reflected signal RS0′ representative of radiated electromagnetic energy reflected from first substance 12′ detected using antenna 18′ and data representative of baseline reflected signal BRS′ to compute a first time difference between first reflected signal RS0′ and a baseline time delay (see block 602′); use the first time difference to compute distance h0′ between antenna 18′ and first substance 12′ (see block 604′); use the data representative of first reflected signal RS0′ and the data representative of baseline reflected signal BRS′ to compute a power relation between the first reflected signal RS0′ and the baseline reflected signal BRS′ (see block 606′); use the power relation to compute a permittivity ∈₁ of the first substance 12′ (see block 608′); use data representative of second reflected signal RS1′ representative of radiated electromagnetic energy reflected from second substance 14′ detected using antenna 18′ and the data representative of first reflected signal RS0′ to compute a second time difference between first reflected signal RS0′ and the second reflected signal RS1′ (see block 610′); and use the second time difference and the computed permittivity ∈₁ of first substance 12′ to compute layer thickness h1′ of first substance 12′.

As described above, apparatus 10′ may also be used to determine properties such as dielectric properties of the multilayer system and layer thickness h2′ of second substance 14′ in addition to layer thickness h1′ of first substance. Accordingly, in some embodiments, method 600′ may further comprise: obtaining a dielectric loss tangent tan δ₁ of first substance 12′ based on the computed permittivity ∈₁ of first substance 12′; and using the dielectric loss tangent tan δ₁ of first substance 12′ to compute permittivity ∈₂ of second substance 14′.

In some embodiments, method 600′ may further comprise: using data representative of third reflected signal RS2′ representative of radiated electromagnetic energy reflected from bottom wall 16B′ of tank 16′; computing a third time difference between second reflected signal RS1′ and third reflected signal RS2′; and using the third time difference and the computed permittivity ∈₂ of second substance 14′ to compute layer thickness h2′ of second substance 14′.

In some embodiments, method 600′ may further comprise using a total height ht′ of tank 16′, distance h0′ between antenna 18′ and first substance 12′, and, layer thickness h1′ of first substance 14′ to compute layer thickness h2′ of second substance 14′.

In some embodiments, method 600′ may further comprise: using data representative of third reflected signal RS2′ representative of radiated electromagnetic energy reflected from bottom wall 16B′ of tank 16′; computing a third time difference between second reflected signal RS1′ and third reflected signal RS2′; and using the third time difference and a total height ht′ of tank 16′, computing a permittivity E₂ of second substance 14′.

In some embodiments, method 600′ may further comprise using the computed permittivity ∈₁ of first substance 12′, the computed permittivity ∈₂ of second substance 14′, distance h0′ between antenna 18′ and first substance 12′ and layer thickness h1′ of first substance 14′ to compute a dielectric loss tangent tan δ₁ of first substance 12′.

In some embodiments, method 600′ may further comprise using the computed permittivity ∈₁ of first substance 12′, the computed permittivity ∈₂ of second substance 14′, distance h0′ between antenna 18′ and first substance 12′, layer thickness h1′ of first substance 14′ and total height ht′ of tank 16′ to compute dielectric loss tangent tan δ₂ of second substance 14′.

As explained above, baseline reflected signal BRS′ may comprise an expected reflected signal representative of radiated electromagnetic energy reflected from bottom wall 16B′ of tank 16′ when tank 16′ is substantially empty.

As explained above, the baseline time delay may comprise a time period between the transmission of transmitted signal TS′ and detection of a reflected signal RS′ representative of radiated electromagnetic energy reflected from bottom wall 16B′ of tank 16′ when tank 16′ is substantially empty.

Various aspects of the present disclosure may be embodied as an apparatus, method or computer program product. Accordingly, aspects of the present disclosure may take the form of an entirely hardware embodiment, an entirely software embodiment or an embodiment combining software and hardware aspects.

Furthermore, aspects of the present disclosure may take the form of a computer program product embodied in one or more non-transitory computer readable medium(ia) having computer readable program code (machine-readable instructions) embodied thereon. The computer program product may, for example, be executed by a computer, processor or other suitable logic circuit to cause the execution of one or more methods disclosed herein in entirety or in part. Computer program code for carrying out operations for aspects of the present disclosure may be written in any combination of one or more programming languages, including an object oriented programming language and/or conventional procedural programming languages. The program code may execute entirely or in part by processor 32′ (see FIG. 17) or other computer.

In some cases, the layer thickness resolution that may be measured using the methods disclosed herein may be limited by the width of the pulse (e.g., RS0′, RS1′, RS2′) by the relation of Equation 16′ below

$${T}_{r} = \frac{{ct}_{width}}{2 \sqrt{{ɛ}_{r}}} \qquad Equation {16}^{′}$$

where ∈ᵣ is the relative permittivity of the layer (e.g., first substance 12′ or second substance 14′). For example, with oil with a relative permittivity of 2.4 and a pulse width of 600 ps, this may amount to a resolution of 5.8 cm before the pulses begin to overlap. Additional computations may be required to resolve overlapping pulses that are due to relatively thin layer thicknesses.

Subsequent reflections from within a single layer may be greatly reduced in amplitude compared to the first reflection associated with that layer, but may nevertheless overlap with other reflections/pulses in reflected signal RS′. However, the ability to detect where these reflections occur after finding height h0′ and permittivity E₁ of first substance 12′ can be relatively accurate and such subsequent pulses may be compensated for by identifying such pulses using the “peak finding” step described above (see Equation 2′) and then ignoring such pulses when conducting the above computations or filtering it out.

Also, the reflections off of objects that lie directly in the path of the antenna 18′ may be ignored or removed from the reflected signal RS′ if the locations of such objects is known and the level and permittivity of the substance(s) over it can still be accurately determined. However, if such object blocks one or more layers below it, it may not be possible, depending on the particular situation, to fully characterize those one or more layers that are obstructed by the object.

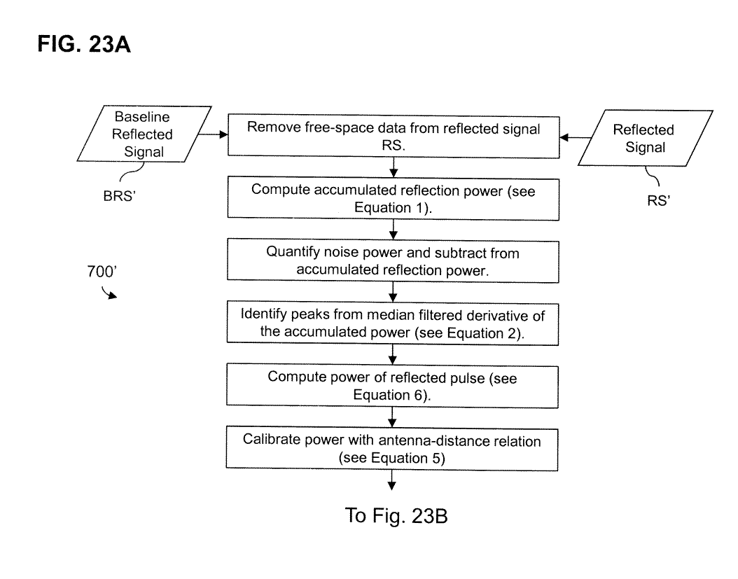

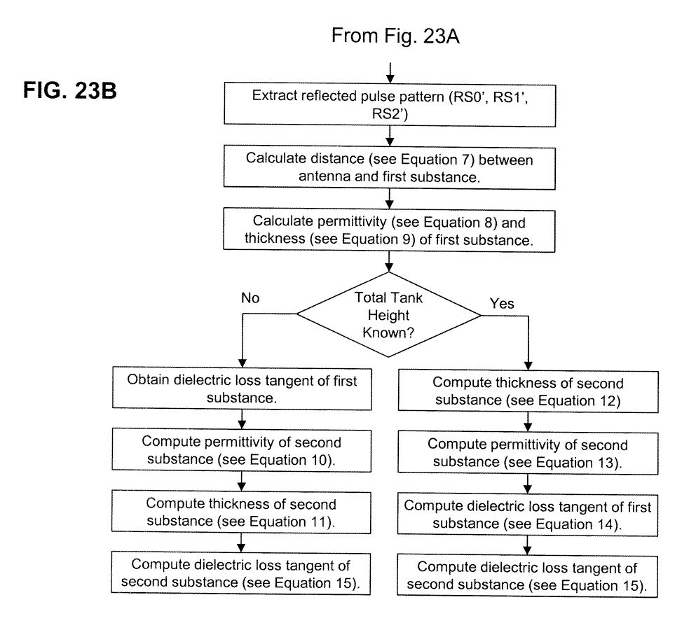

FIG. 23 is a flowchart illustrating an exemplary method 700′ for evaluating one or more properties of a two-layer system comprising first substance 12′ and second substance 14′ in tank 16′. Method 700′ comprises tasks previously described above and therefore the description of such tasks will not be repeated. Apparatus 10′ could be used to perform method 700′ or part(s) thereof. Also, various blocks of method 700′ make reference to equations previously introduced above. Even though FIG. 23 is specific to a two-layer system, it could be modified for multi-layer systems as demonstrated by method 800′ described below.

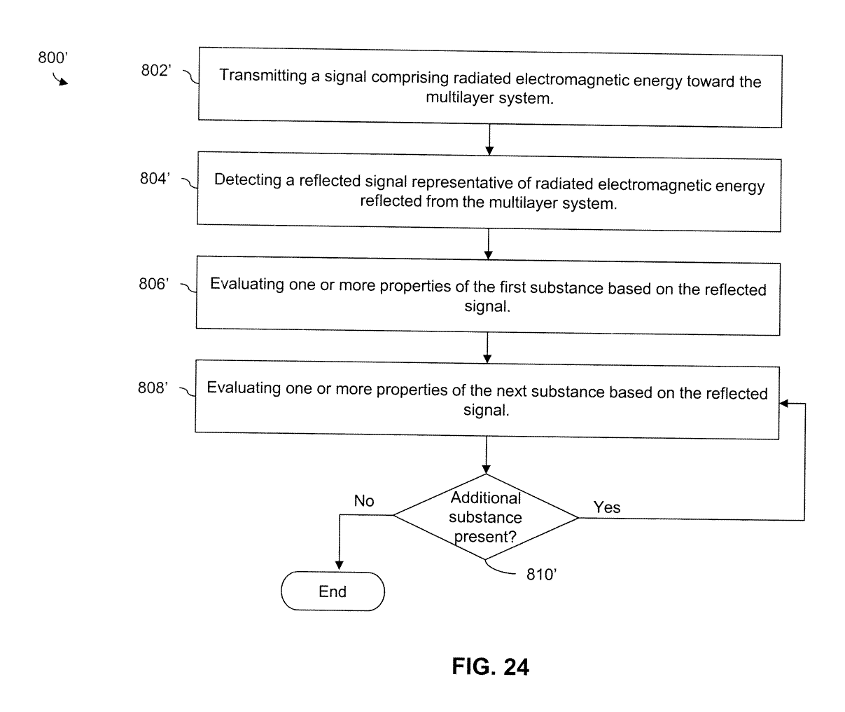

FIG. 24 is a flowchart illustrating an exemplary method 800′ for evaluating one or more properties of a multilayer system. Method 800′ shows that the various methods described herein could be used on multilayer systems comprising more than two layers/substances. For example, method 800′ may comprise: transmitting a signal TS′ comprising radiated electromagnetic energy toward the multilayer system (see block 802′); detecting a reflected signal RS′ representative of radiated electromagnetic energy reflected from the multilayer system (see block 804′); determining one or more properties of first substance 12′ based on reflected signal RS′ (see block 806′); determining one or more properties of the next substance (e.g., 14′) based on reflected signal RS′ (see block 808′); at decision block 810′, determining whether an additional layer/substance is present in the multilayer system and, if so, returning to block 808′. The determination of whether an additional layer/substance is present may be made based on the detection of additional reflections/pulses that may be representative of additional interfaces in the multi-layer system.

### Examples

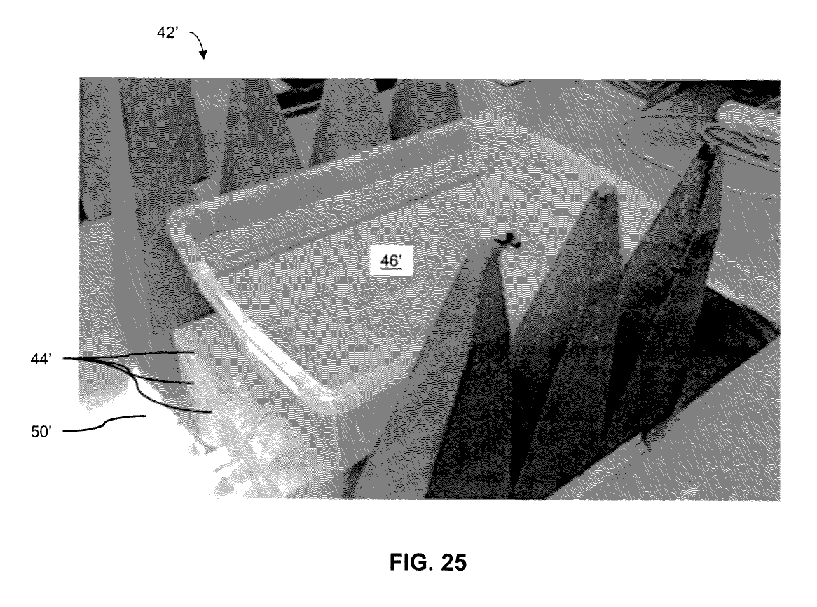

The following description and FIGS. 25-32E relate to experiments that were conducted using different configurations of antennas in conjunction with the methods disclosed herein to evaluate properties of an experimental multilayer system 42′.

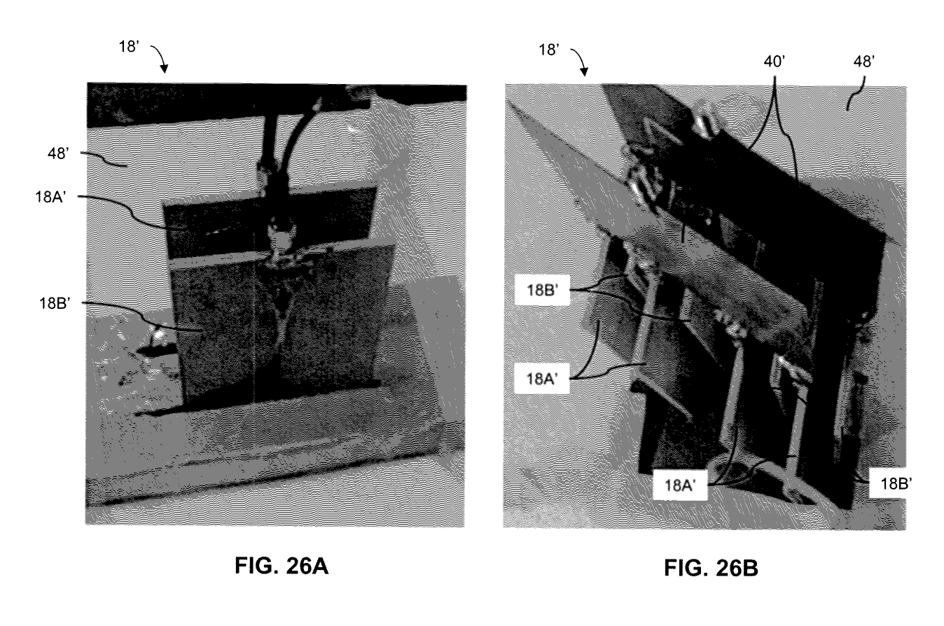

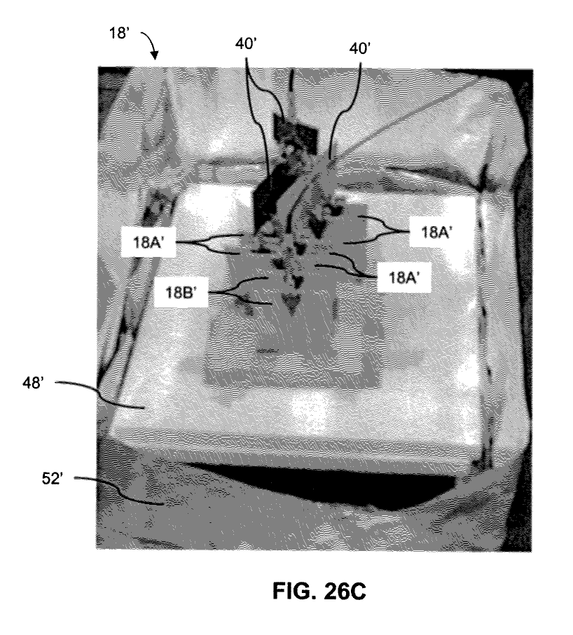

FIG. 25 shows multilayer system 42′ that was used during the experiments. Multi-layer system 42′ comprises marble tiles 44′ measuring about 2 feet by 1 foot and stacked 10 high for a total measured height of 10.2±0.2 cm, a container of oil 46′ having a height of about 13.5±0.2 cm and stacked sheets 48′ (see FIGS. 26A-26C) of polystyrene foam sold under the trade name STYROFOAM supporting antenna 18′ above oil 46′ and also used to adjust the height of antenna 18′ from oil 46′. There was also an air gap of about 1.5 cm high between oil 46′ and the polystyrene foam sheets 48′. A sheet of aluminum foil was placed under marble tiles 44′ to provide a metal backing 50′ for multilayer system 42′.

Based on the measured reflection time between layers and the measured heights, the relative permittivity of oil 46′ was determined to be about 2.4±0.1, the relative permittivity of marble 44′ was determined to be about 8.5±0.5 and the relative permittivity of the polystyrene foam was determined to be about 1.04.

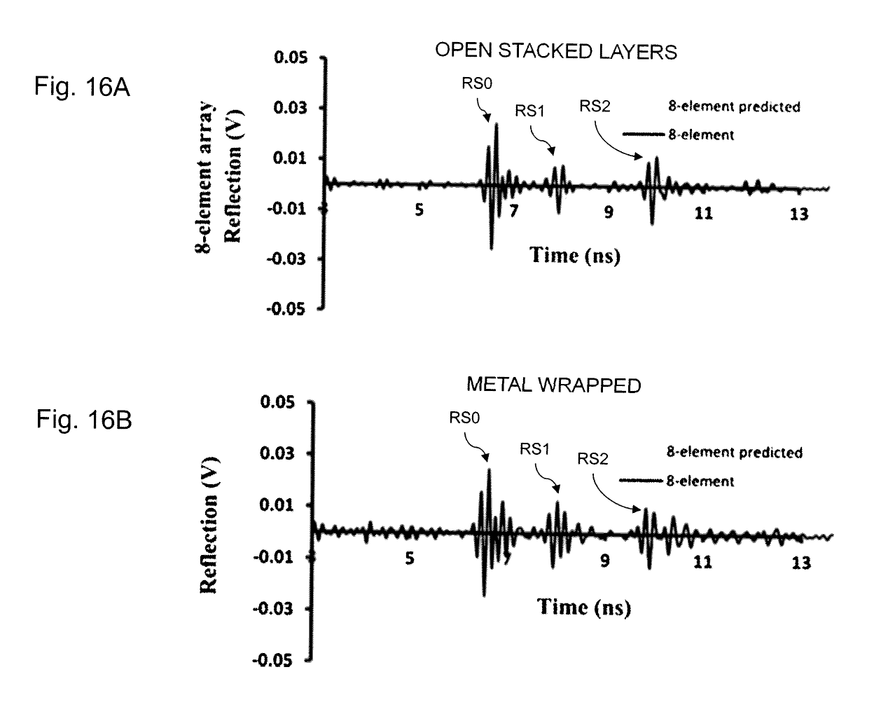

The initially assumed dielectric tangent (tan d or tan δ) for oil 46′ was about 0.03 and the assumed dielectric tangent for the marble was about 0.015. The dielectric tangents can vary for materials and they have not been directly measured in these experiments. The experiments were also conducted with the multilayer system 42′ being wrapped in 45 cm high aluminum foil 52′ (shown in FIG. 26C) to mimic the situation inside a metallic tank. The metal wrapping 52′ resulted in a noisier environment. As shown below, the presence of the metal wrapping 52′ had a significant impact on measurements using just single antenna elements 18A′. Three different antenna configurations were used to compare the accuracy of the detected signals. The accuracy using the 8-element transmitting antenna to a two-element receiving antenna with respect to distance is plotted in FIGS. 16A-16E.

FIGS. 10A-10C show the different configurations of antennas 18′ that were used in the examples described herein. The antenna elements 18A′, 18B′ were Vivaldi-type antenna elements 18A′, 18B′ as described above. In these examples, different antenna elements 18A′, 18B′ were used for transmitting and detecting signals but it is understood that the same antenna element(s) 18A′, 18B′ could be used for both transmitting and detecting functions. FIG. 26A′ is a photograph of an exemplary antenna 18′ comprising a single transmitting element 18A′ and a single detecting element 18B′. FIG. 26B is a photograph of another exemplary antenna 18′ comprising four transmitting elements 18A′ and four detecting elements 18B′. FIG. 26C is a photograph of another exemplary antenna 18′ comprising eight transmitting elements 18A′ and two detecting elements 18B′.

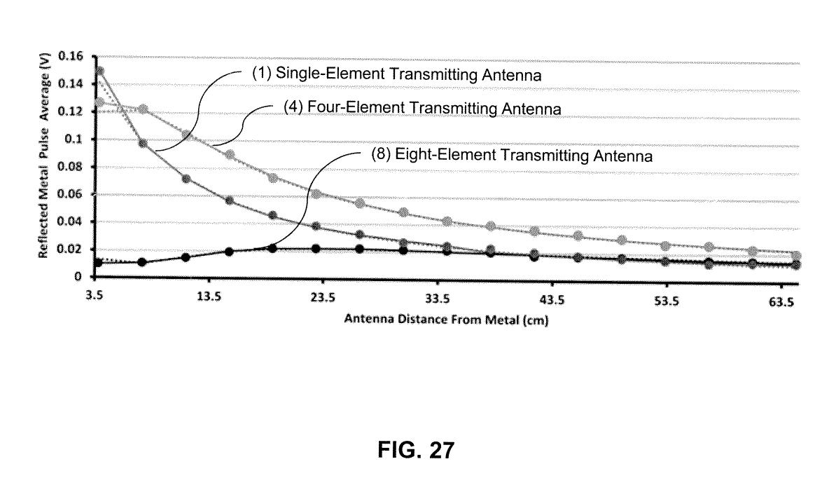

FIG. 27 shows a plot of the average voltage of a signal (i.e., pulse) reflected from metal backing 50′ versus the distance of antenna 18′ from metal backing 50′ without the presence of multilayer system 42′. The average voltage is representative of a detected baseline reflected signal BRS′ without multilayer system 42′ (i.e., representing an empty tank). The information on the plot of FIG. 27 may be obtained during a calibration procedure, stored and used later during measurement to determine the amount of power that is dissipated in multilayer system 42′. Such voltage may be obtained from baseline reflected signal BRS′ as described above and may be acquired for the purpose of obtaining system characteristics of antenna 18′ at various distances from metal backing 50′, which may be analogous to bottom wall 16B′ of tank 16′.

The information presented in the plot of FIG. 27 may be fitted to Equation 3′ or Equation 4′ presented above for the purpose of characterizing antenna 18′ system. For the purpose of the present examples, the variables computed for Equation 4′ were used for calibration in the methods disclosed herein.

The reflection data for the single-element transmitting antenna (see FIG. 26A) and for the four-element transmitting antenna (see FIG. 26B) strongly follow an inverse distance relation that would be expected for the far field in the range of distances tested. However, the effective radius of the eight-element transmitting antenna to the two-element receiving antenna (see FIG. 26C) is relatively larger and may depend relatively strongly on the modifying terms up to a distance of about 30 cm. Since the amplitudes of the inverse relation are larger for the eight-element transmitting antenna and the four-element transmitting antenna, the overall gain is shown to be higher.

Since the excitation pulse (i.e., transmitted signal TS′) can have different shapes and amplitudes with possible different delays depending on the cables to the antenna element(s) 18A′, reflection measurements are taken with a known distance to antenna 18′ and the distance-amplitude relation for the antenna type was re-fitted with the new setup to extrapolate the expected amplitude at other distances.

FIGS. 28A-30B show plots of reflected signal RS′ expressed as voltage versus time for open stacked layers where multilayer system 42′ is not metal wrapped and metal wrapped where metal wrapping 52′ is present around multilayer system 42′ for the different configurations of antennas. The different components (i.e., reflected pulses) of interest in reflected signal RS′ are identified on the plots as first reflected signal RS0′, second reflected signal RS1′ and third reflected signal RS2′. The reflection data for the three different antenna configurations was acquired with the antennas positioned 39.6±0.2 cm above oil 46′. Predicted reflection data was determined based on the pre-determined (e.g., obtained by other methods) layer heights and permittivity values and is also plotted in stippled lines to show the difference between the acquired data and the predicted reflection data.

FIGS. 28A and 28B respectively show plots of reflected signal RS′ (RS0′, RS1′, RS2′) for open stacked layers and metal wrapped layers using the antenna configuration of FIG. 26A having a single transmitting element 18A′ and a single detecting element 18B′. The reflection data acquired with metal wrapping 52′ is shown to be relatively more noisy than the data acquired without the presence of metal wrapping 52′.

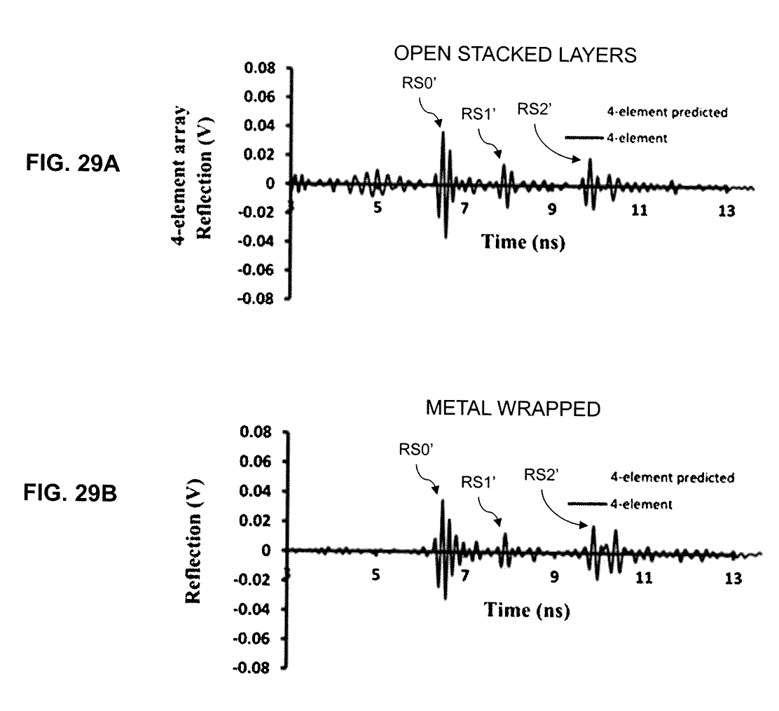

FIGS. 29A and 29B respectively show plots of reflected signal RS′ (RS0′, RS1′, RS2′) for open stacked layers and metal wrapped layers using the antenna configuration of FIG. 26B having four transmitting elements 18A′ and four detecting elements 18B′. The reflection data acquired with metal wrapping 52′ is shown to be more noisy than the data acquired without the presence of metal wrapping 52′ but the amount of noise appears to be less than the noise present in the data shown in FIG. 28B and obtained with the antenna of FIG. 26A.

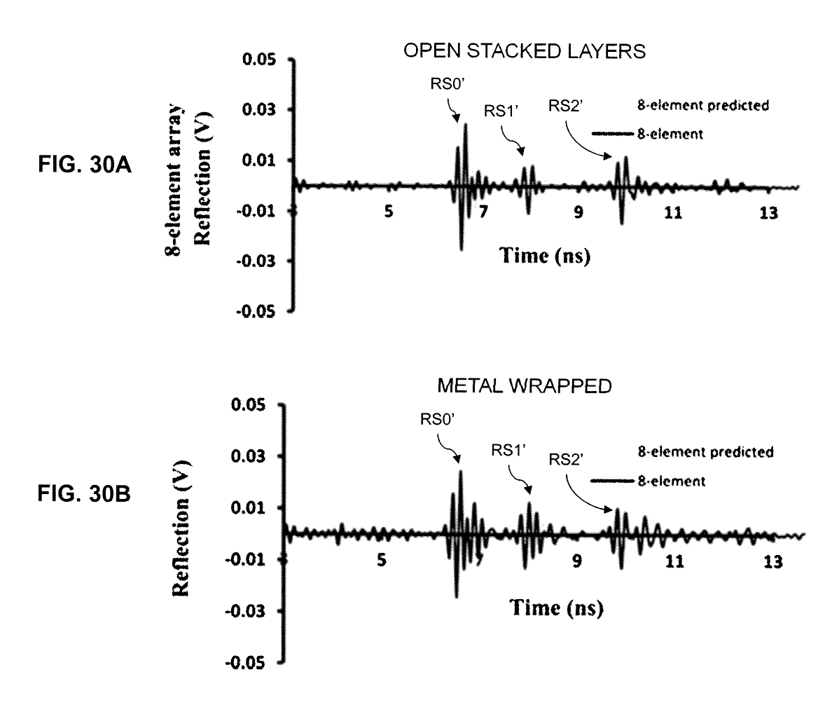

FIGS. 30A and 30B respectively show plots of reflected signal RS′ (RS0′, RS1′, RS2′) for open stacked layers and metal wrapped layers using the antenna configuration of FIG. 26C having eight transmitting elements 18A′ and two detecting elements 18B′. The reflection data acquired with metal wrapping 52′ is shown to be slightly more noisy than the data acquired without the presence of metal wrapping 52′ but the amount of noise again appears to be less than the noise present in the data shown in FIG. 28B and obtained with the antenna of FIG. 26A.

The data displayed in FIGS. 28A-30B shows that the presence of metal wrapping 52′ added noise to reflected signal RS′ and is likely due to side reflections. However, the amount of noise was greater for the case using the antenna configuration of FIG. 26A having the single transmitting element 18A′ and the single detecting element 18B′.

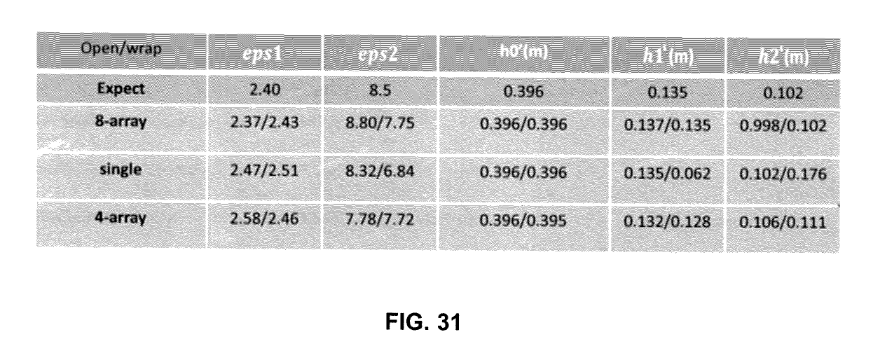

FIG. 31 shows a table of the expected values for relative permittivity (eps1, eps2) and thicknesses (h0′, h1′, h2′) of the different substances/layers in multilayer system 42′ together with the values determined using each antenna configuration of FIGS. 26A-26C in the open and metal wrapped conditions.

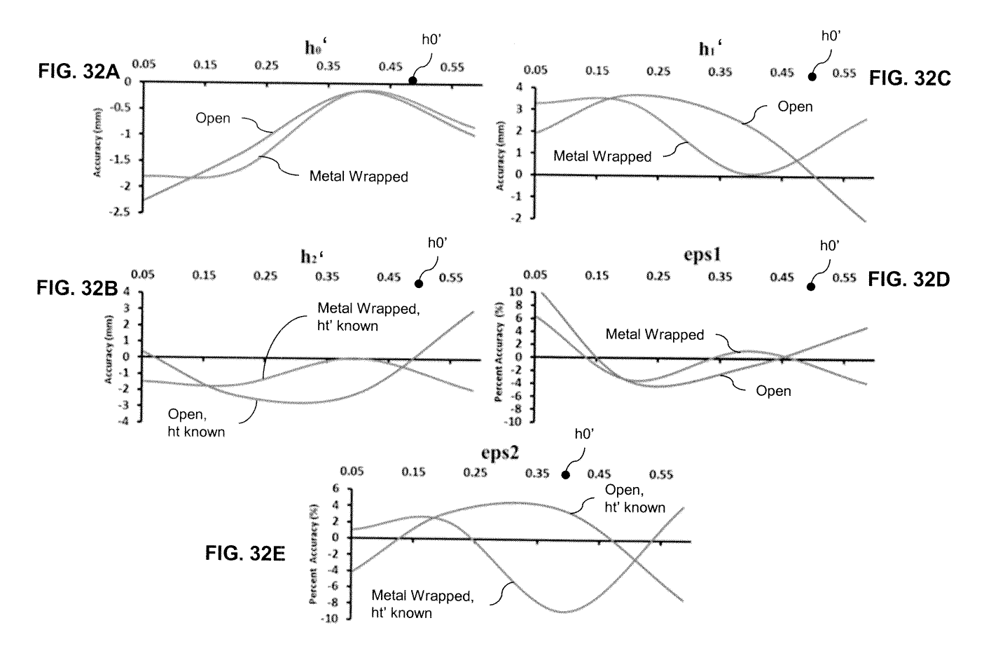

FIGS. 32A-32E are plots of the differences between the expected values for relative permittivity (eps1, eps2) and thicknesses (h0′, h1′, h2′) of the different substances/layers in multilayer system 42′ and the values determined using the antenna configuration shown in FIG. 26C having eight transmitting elements 18A′ and two detecting elements 18B′. The y-axis (ordinate) of each plot in FIGS. 32A-32E represents the error in terms of accuracy (mm or % deviation) and the x-axis (abscissa) represents the distance h0′ between antenna 18′ and the top surface (i.e., level h0′) of oil 46′. Each plot shows two curves where one curve (labelled as “metal wrapped”) was acquired with the presence of metal wrapping 52′ and the other curve (labeled as “normal”) was acquired without metal wrapping 52′.

In these cases, it is assumed that the total height ht′ of the tank is known so the more accurate expected value of the layer thickness h2′ based on total tank height ht′ can be used. In addition, the expected value of permittivity ∈₂ of marble 44′ is based on first predicting thickness h2′ of the marble layers and the measured time between the second reflected signal RS1′ and the third reflected signal RS2′ is used.

In this set of measurements, the accuracy of the measured thickness h0′ of the first layer is within 2 mm, the measured thickness h1′ is within 4 mm and so is the thickness h2′ if the total tank height ht′ is known. Without exact knowledge of the dielectric tangent tan δ₁ of the first substance, the permittivity ∈₂ and thickness h1′ of the prediction/measurement of the second substance was less accurate. The permittivity ∈₁ of the first substance was predicted to within 10% accuracy, but without a measured reflected signal RS2′ from the metal backing 50′, the accuracy of predicting/measuring the permittivity ∈₂ of the second substance depended strongly on the accuracy of the property(ies) determined for the first substance.

The set-up used in these experiments may not represent optimal conditions for measurement of properties of multilayer systems. For example, the width of multilayer system 42′ and the tank defined by metal wrapping 52′ was relatively small compared to what would normally be encountered in the field.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. The present disclosure may be embodied in other specific forms without departing from the subject matter of the claims.

Also, one skilled in the relevant arts will appreciate that while the methods and apparatus disclosed and shown herein may comprise a specific number of elements/components, the methods and apparatus could be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

1. A sensing system for measuring a parameter of at least one dielectric substance, the sensing system comprising:
a tank for containing the at least one dielectric substance;
a directional sensor having:
an antenna comprising at least one array of at least two antenna elements, the antenna elements being ultra-wide band antenna elements, the antenna being mounted to the tank and adapted to emit a signal comprising radiated electromagnetic energy toward the at least one dielectric substance and along a signal path of the tank, the antenna being further adapted to detect a signal after propagation thereof along the signal path;
an antenna controller being operatively coupled to the antenna, the antenna controller being adapted to drive the emitted signal based on emission data, adapted to detect the detected signal and to generate detection data indicative of the detected signal; and
a computing device operatively coupled to the antenna controller, the computing device comprising a data processor and a medium containing machine-readable instructions executable by the data processor and configured to cause the data processor to determine the parameter of the dielectric substance in the tank based on the detection data.

2. The sensing system of claim 1, wherein the at least one array of the antenna comprises four antenna elements.

3. The sensing system of claim 1, wherein the at least one array of the antenna comprises eight antenna elements.

4. The sensing system of claim 1, wherein the transmitted signal has a frequency range of 3.1 GHz to 10.6 GHz.

5. The sensing system of claim 4, wherein at least one of the at least two antenna elements of the at least one array of the antenna is provided in the form of at least one of a monocone antenna, a horn antenna, a Vivaldi antenna and an antipodal Vivaldi antenna.

6. The sensing system of claim 1, wherein the at least two antenna elements of the at least one array of the antenna are planar and wherein the at least two antenna elements of the are spaced from one another, the spacing being defined by at least one spacing parameter.

7. The sensing system of claim 6, wherein the spacing is in a direction perpendicular to the signal path.

8. The sensing system of claim 1, wherein the dielectric substance to be sensed is a liquid.

9. The sensing system of claim 1, wherein the parameter is a thickness of at least the dielectric substance.

10. The sensing system of claim 1, wherein the parameter is a dielectric permittivity of at least the dielectric substance.

11. The sensing system of claim 1 further comprising at least one power divider to operative couple the antenna to the antenna controller, the at least one power divider being is provided in the form of a Wilkinson power divider.

12. The sensing system of claim 1, wherein one of the array of antenna elements of the antenna is used for transmitting the signal to be transmitted and another one of the array of antenna elements of the antenna is used for detecting the signal to be detected.

13. The sensing system of claim 12, wherein the other one of the array of antenna elements is used in reflection.

14. A method for measuring a parameter of at least one dielectric substance in a tank, the method comprising the steps of:
emitting a signal comprising radiated electromagnetic energy from a directional sensor having an array of antenna elements into the at least one dielectric substance and along a signal path in the tank, the antenna elements being ultra-wide band antenna elements, the dielectric substance and the tank reflecting the signal;
receiving the reflected signal; and
measuring the parameter based on the received signal.

15. The method of claim 14, wherein the parameter is a thickness of the at least one dielectric substance.

16. (canceled)

17. (canceled)

18. (canceled)

19. (canceled)

20. (canceled)

21. A method for evaluating properties of a multilayer system comprising a first substance and a second substance in a tank, the first substance having a different permittivity than the second substance, the second substance being disposed between the first substance and a wall of the tank, the method comprising:
transmitting a signal comprising radiated electromagnetic energy from an antenna toward the multilayer system;
detecting a first reflected signal representative of radiated electromagnetic energy reflected from the first substance;
using a first time difference between the first reflected signal and a baseline time delay determined from a baseline reflected signal, computing a distance between the antenna and the first substance;
using a power relation between the first reflected signal and the baseline reflected signal, computing a permittivity of the first substance;
detecting a second reflected signal representative of radiated electromagnetic energy reflected from the second substance;
using a second time difference between the first reflected signal and the second reflected signal and also using the computed permittivity of the first substance, computing a layer thickness of the first substance.

22. The method as defined in claim 21, comprising:
obtaining a dielectric loss tangent of the first substance based on the computed permittivity of the first substance; and
using the dielectric loss tangent of the first substance, computing the permittivity of the second substance.

23. The method as defined in claim 22, comprising:
detecting a third reflected signal representative of radiated electromagnetic energy reflected from the wall of the tank; and
using a third time difference between the second reflected signal and the third reflected signal and also using the computed permittivity of the second substance, computing a layer thickness of the second substance.

24. The method as defined in claim 21, comprising using a total height of the tank, the distance between the antenna and the first substance, and, the layer thickness of the first substance, computing a layer thickness of the second substance.

25. The method as defined in claim 21, comprising:
detecting a third reflected signal representative of radiated electromagnetic energy reflected from the wall of the tank; and
using a third time difference between the second reflected signal and the third reflected signal and also using a total height of the tank, computing a permittivity of the second substance.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
